(19) United States
(12) Patent Application Publication
(10) Pub. No.: US 2006/0080034 A1
(43) Pub. Date: Apr. 13, 2006

(54) Car navigation device

(75) Inventor: Kazumi Hayashi, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/159,150

(22) Filed: Jun. 23, 2005

(30) Foreign Application Priority Data
Jun. 25, 2004 (JP) 2004-187838

(51) Int. Cl. G01C 21/36

(52) U.S. Cl. 701/211; 701/200

(57) ABSTRACT

There is provided a car navigation device for performing voice guidance on a guiding route to a predetermined destination. The car navigation device has history recording means and change means. The history recording means records the vehicle's driving history on a storage medium. The change means changes voice guidance quantities for a given section in the guiding route based on the driving history recorded by the history recording means concerning the given section.

### CROSS REFERENCE TO RELATED APPLICATIONS

This application is based on and incorporates herein by reference Japanese Patent Application No. 2004-187838 filed on Jun. 25, 2004.

### FIELD OF THE INVENTION

The present invention relates to a car navigation device which provides voice guidance to a predetermined destination along a guiding route and changes the voice guidance quantity.

### BACKGROUND OF INVENTION

Conventionally, there has been widely used a car navigation device that is mounted on a vehicle, determines a guiding route to a predetermined destination, and guides the vehicle's traveling based on the determined guiding route. Generally, such navigation device provides visual guidance by displaying images composed of the vehicle position and the guiding route overlapping with each other on a map. In addition, the navigation device provides audio guidance at positions such as unstraight intersections where it is especially preferable to call a driver's attention.

Patent Document 1 discloses the technology capable of presetting the information amount of such voice guidance.

The car navigation device disclosed in Patent Document 1 is capable of changeover between three voice guidance types such as large, medium, and small voice information amounts based on user's setup operations. Upon arrival at a destination, the car navigation device can change the voice guidance type to the voice guidance having the large information amount. Further, based on user's setup operations, the car navigation device can determine at which point distant from the destination the changeover should take place.

Patent Document 1: JP-2001-272243A

The inventors found that it may be inconvenient when the navigation device gives no change to the information amount of the voice guidance on a route in an unvisited region or a familiar region including the home and its vicinity and commuter roads. That is, a driver may feel it annoying to be provided with the same voice guidance for familiar places as that for unfamiliar places.

To solve this problem, for example, the technology described in Patent Document 1 may be used to decrease the information amount of the voice guidance at familiar places and increase the information amount of the voice guidance at unfamiliar places. However, this method requires the driver's operations to vary the information amount as needed.

### SUMMARY OF THE INVENTION

The present invention has been made in consideration of the foregoing. It is therefore a first object of the present invention to provide a car navigation device capable of automatically changing the amount of guidance voice according to the presence or absence of the driver's sense of locality as long as conditions permit

It is a second object of the present invention to provide a car navigation device which uses an unprecedented new method to change the voice guidance quantity according to user's manual operations.

To achieve the above-mentioned objects, the present invention provides a car navigation device for performing voice guidance on a guiding route to a predetermined destination. The car navigation device records vehicle's driving history on a storage medium. The car navigation device functions based on the driving history concerning a given section in a guiding route and changes the voice guidance quantity in the given section.

In this manner, even the same running section causes the voice guidance quantity to automatically change depending on the vehicle's driving history. The result more or less depends on whether or not the vehicle's driver has a sense of locality.

The car navigation device records frequently used facility information about a facility in a storage medium based on the use of a facility for the number of times (or at a frequency) greater than or equal to a threshold value. When a given section in a guiding route includes a facility associated with the frequently used facility information, the voice guidance may be performed for the given section using one of two available voice guidance systems, i.e., a system having a smaller voice guidance quantity. In this manner, the voice guidance quantity can be changed based on the facility utilization situation as the driving history.

The voice guidance may be performed for a given section using one of two available voice guidance systems, i.e., a system having a smaller voice guidance quantity. This system may be selected when there is a facility concerning the frequently used facility information in a partial section containing a center point of the given section in a guiding route. The reason is as follows. It is highly possible that the entire given section is frequently used when a facility concerning the frequently used facility information is located near the center of the given section than at the end thereof.

The car navigation device may have a radio communication function. The frequently used facility information about a facility may be recorded on a storage medium based on communication with a communication device installed at the facility by using the radio communication means for the number of times (or at a frequency) greater than or equal to a threshold count. Since the radio communication with the communication device installed at the facility is used as a criterion, it is possible to easily determine whether or not the facility has been used.

One-time communication signifies transmission or reception of a sequence of data for purchasing goods, entering a parking area, and the like, not each event of data transmission or reception in the sequence of data communication.

The car navigation device may have a function to detect a vehicle stopping state as an example of the criterion for determining whether or not a facility has been used. The frequently used facility information about the facility may be recorded in a storage medium based on a fact that a vehicle stops longer than or equal to a threshold time in the facility as often as to be greater than or equal to a threshold count.

Since utilization times for facilities depend on the types of businesses for facilities, the threshold times may vary with the types of businesses for facilities. This makes it possible to more finely determine whether or not the facility has been used.

The car navigation device displays on a map an outlined route having a group of representative routing points in a guiding route to a predetermined destination. The voice guidance may be performed for a section between two representative routing points containing a position for a facility related to the frequently used facility information in a guiding route. To change between voice guidance quantities in this case, it may be preferable to use one of two available voice guidance systems, i.e., a system having a smaller voice guidance quantity. This makes it easy for a vehicle user to identify which voice guidance quantity is large or small in the respective sections.

The car navigation device has a function to detect the user's specification of a representative routing point in an outlined route. The voice guidance may be changed as follows. The voice guidance may be performed for a section from a representative routing point concerning specification to one end point of the outlined route using one of two available voice guidance systems having a smaller voice guidance quantity. Alternatively, the voice guidance may be performed for a section therefrom to the other (or opposing) end point using one of two available voice guidance systems having a larger voice guidance quantity. This enables users to interactively specify a large or small voice guidance quantity.

Further, the voice guidance may be changed as follows. When one end point of the outlined route is home-registered, the voice guidance may be performed for a section from a representative routing point concerning the specification to the home-registered end point using one of two available voice guidance systems having a smaller voice guidance quantity. This is because the vehicle's user is considered to be familiar with an area containing the home-registered position.

Moreover, the voice guidance may be changed as follows. There may be as many used facilities as a first specified count or more near one end point of the outlined route. In this case, the voice guidance may be performed for a section from a representative routing point concerning the specification to the one end point using one of two available voice guidance systems having a smaller voice guidance quantity. This is because the vehicle's user is considered to be familiar with an area containing many used facilities.

Furthermore, the voice guidance may be changed as follows. There may be as many used facilities as a second specified count or less near one end point of the outlined route. In this case, the voice guidance may be performed for a section from a representative routing point concerning the specification to the one end point using one of two available voice guidance systems having a larger voice guidance quantity. This is because the vehicle's user is considered to be unfamiliar with an area containing a few used facilities.

The car navigation device may be constructed as follows. It may be configured to perform voice guidance for a section from a representative routing point in the outlined route to one end point of the outlined route using one of two available voice guidance systems having a smaller voice guidance quantity. Further, it may be configured to perform voice guidance for a section therefrom to the other end point using one of the two available voice guidance systems having a larger voice guidance quantity. When the user's specification of the representative routing point is detected, the voice guidance may be performed for a section from the representative routing point to the one end point using one of the two available voice guidance systems having a larger voice guidance quantity. The voice guidance may be performed for a section from the representative routing point to the other end point using one of the two available voice guidance systems having a smaller voice guidance quantity.

In this manner, the user can easily toggle between the large and small voice guidance quantity settings with reference to the representative routing point.

The above-mentioned display function for outlined routes can display representative routing points in a guiding route to a predetermined destination and an outlined route composed of links connecting between these representative routing points on a map. The car navigation device may have a function to detect the user's link specification in the outlined route. Still further, the voice guidance may be changed as follows. It may be configured to perform voice guidance for a section equivalent to a link concerning the specification using one of two voice guidance systems with different voice guidance quantities. In such case, it may be preferable to perform the voice guidance for the section so as to use the other of the two voice guidance systems.

In this manner, the user can easily toggle between the large and small voice guidance quantity settings in a section equivalent to the link.

There may be a case where a vehicle deviates from a guiding route during the voice guidance using one of two available voice guidance systems having a smaller voice guidance quantity. It is supposed that the vehicle can return to the guiding route by turning at intersections less frequently than the specified number of turns. In such case, the car navigation device may be constructed to perform the voice guidance for returning to the guiding route using one of two available voice guidance systems having a smaller voice guidance quantity.

The car navigation device may change the voice guidance as follows. There may be a case where the voice guidance is performed for a reverse route to a starting point tracking reversely to a guiding route to a predetermined destination. In such case, it may be preferable to assume the voice guidance quantity for a section in the reverse route to be equal to the voice guidance quantity for the section applicable to the voice guidance for the guiding route. Consequently, even on the reverse route, the user can use the large and small voice guidance quantity settings for the corresponding guiding route.

A storage medium may store the frequently used facility information indicating that guidance voice data about the facility will be used for the voice guidance.

According to a second aspect of the present invention, a car navigation device has the following functions to perform voice guidance on a guiding route to a predetermined destination. There is provided an outlined display function to display on a map an outlined route having a group of representative routing points in a guiding route to a predetermined destination. Further, there is provided a function to detect user's specification of a representative routing point in the outlined route. Moreover, there is provided a function to perform the voice guidance for a section from a representative routing point concerning the detected specification to one end point of the outlined route using one of two available voice guidance systems having a smaller voice guidance quantity and to perform the voice guidance for a section therefrom to the other (opposing) end point using one of two available voice guidance systems having a larger voice guidance quantity.

Such car navigation device provides an unprecedentedly new method so that a user can manually change voice guidance quantities.

The voice guidance quantities may be changed as follows. When one end point of the outlined route is home-registered, the voice guidance may be performed for a section from a representative routing point concerning the specification to the home-registered end point using one of two available voice guidance systems having a smaller voice guidance quantity.

Further, the voice guidance quantities may be changed as follows. When there are as many used facilities as a first specified count or more near one end point of the outlined route, the voice guidance may be performed for a section from a representative routing point concerning the specification to the one end point using one of two available voice guidance systems having a smaller voice guidance quantity.

Moreover, the voice guidance quantities may be changed as follows. There may be as many used facilities as a second specified count or less near one end point of the outlined route. In such case, the voice guidance may be performed for a section from a representative routing point concerning the specification to the one end point using one of two available voice guidance systems having a larger voice guidance quantity.

Still further, the car navigation device may be constructed as follows. It is supposed to perform the voice guidance for a section from a representative routing point in the outlined route to one end point of the outlined route using one of two available voice guidance systems having a smaller voice guidance quantity. In addition, it is supposed to perform the voice guidance for a section therefrom to the other end point using one of the two available voice guidance systems having a larger voice guidance quantity. There may be a case of detecting user's specification of the representative routing point. In such case, the voice guidance is performed for a section from the representative routing point to the one end point using one of the two available voice guidance systems having a larger voice guidance quantity Alternatively, the voice guidance is performed for a section from the representative routing point to the other end point using one of the two available voice guidance systems having a smaller voice guidance quantity. In this manner, the user can easily toggle between the large and small voice guidance quantity settings with reference to the representative routing point.

According to a third aspect of the present invention, a car navigation device has the following functions to perform voice guidance on a guiding route to a predetermined destination. There is provided an outlined display function to display representative routing points in a guiding route to a predetermined destination and an outlined route composed of links connecting between these representative routing points on a map. Further, there is provided a function to detect user's specification of a link in the outlined route. Moreover, when it is configured to perform the voice guidance for a section equivalent to a link concerning the detected specification using one of two available voice guidance systems, there is provided a function to change the voice guidance for the section so as to use the other of the two voice guidance systems.

In this manner, the user can easily toggle between the large and small voice guidance quantity settings for a section equivalent to the link. Consequently, an unprecedentedly new method can be provided so that a user can manually change voice guidance quantities.

### BRIEF DESCRIPTION OF THE DRAWINGS

The above and other objects, features, and advantages of the present invention will become more apparent from the following detailed description made with reference to the accompanying drawings. In the drawings:

FIG. 1 shows the hardware configuration of a car navigation device according to a first embodiment of the present invention;

FIG. 2 shows the configuration of facility data stored in an external storage medium;

FIG. 3 shows examples of guidance voice data stored in the external storage medium;

FIG. 4 is an aerial view of a facility where a vehicle downloads voice guidance data;

FIG. 5 is a side view of a vehicle and a facility building;

FIG. 6 shows the hardware configuration of communication equipment;

FIG. 7 shows facility's detailed information transmitted from the communication equipment;

FIG. 8 shows the communication equipment installed at a bridge;

FIG. 9 is a program flowchart;

FIG. 10 is another program flowchart;

FIG. 11 shows part of a program flowchart for a route guidance process;

FIG. 12 shows another part of the program flowchart for the route guidance process;

FIG. 13 shows a display screen to display an image for outlined guidance about all routes;

FIG. 14 shows a link containing a mixture of a section for detailed guidance and a section for simple guidance;

FIG. 15 shows an example of outlined voice guidance about all routes;

FIG. 16 shows conversion relationship between a keyword and registered voice guidance data;

FIG. 17 shows an example of the outlined voice guidance about all routes using the registered voice guidance data;

FIG. 18A shows an example of screen display transition on a display device when a control circuit executes the program;

FIG. 18B shows another example of screen display transition on the display device when the control circuit executes the program;

FIG. 18C shows yet another example of screen display transition on the display device when the control circuit executes the program;

FIG. 19 shows an example of transition of an outlined display screen for all routes on the display device when all guiding routes are configured for detailed voice guidance;

FIG. 20 shows an example of transition of the screen display on the display device when the control circuit executes the program;

FIG. 21 shows another example of transition of the screen display on the display device when the control circuit executes the program;

FIG. 22 shows comparison between screen displays for normal route guidance and corresponding reverse route guidance according to outlined guidance;

FIG. 23 shows a road diagram illustrating selection of facilities targeted for outlined voice guidance;

FIG. 24 is a flowchart of the program executed by the control circuit according to a third embodiment;

FIG. 25 is a flowchart of the program executed by the control circuit for a guiding route retrieval process according to a fourth embodiment;

FIG. 26 shows a display screen representing a route retrieval result independent of a position of a frequently used facility;

FIG. 27 shows a display screen representing a route retrieval result based on a position of a frequently used facility according to the fourth embodiment;

FIG. 28 is a flowchart of the program executed by the control circuit for a reroute process according to a fifth embodiment;

FIG. 29 is a road diagram for explaining distinction between performing simplified reroute voice guidance and performing detailed reroute voice guidance;

FIG. 30 is a flowchart of the program executed by the control circuit according to a sixth embodiment; and

FIG. 31 lists specified times and corresponding categories.

### DETAILED DESCRIPTION OF THE PREFERRED EMBODIMENTS

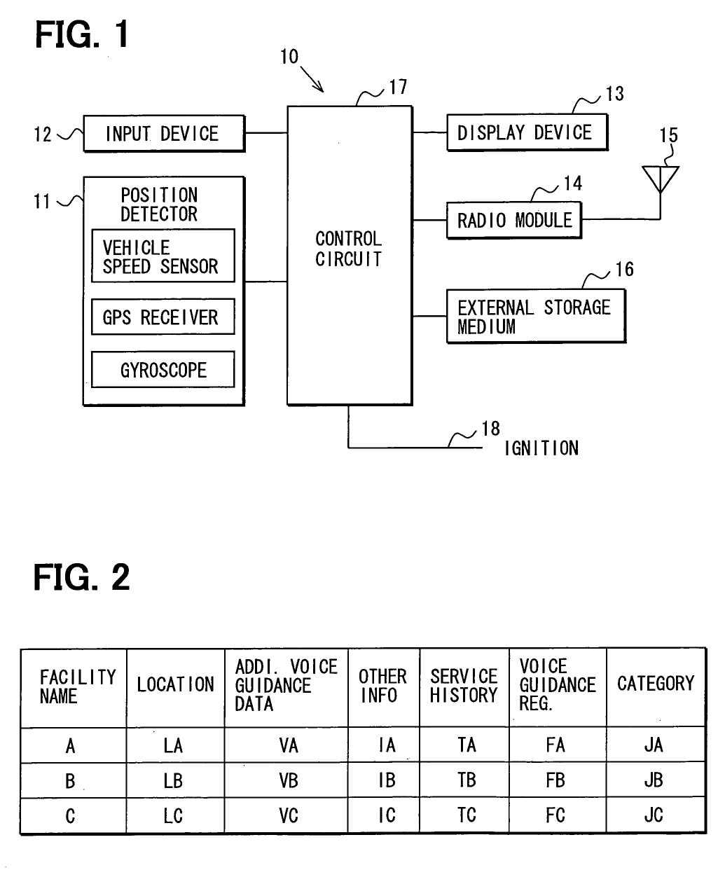

The following describes a first embodiment of the present invention. FIG. 1 shows the hardware configuration of a car navigation device according to the embodiment of the present invention. The car navigation device 10 includes a position detector 11, an input device 12, a display device 13, a radio module 14, an antenna 15, an external storage medium 16, a control circuit 17, and an ignition line 18.

The position detector 11 has known sensors such as a terrestrial magnetism sensor, a gyroscope, a vehicle speed sensor to output pulse signals based on vehicle revolutions, a GPS sensor, and the like. The position detector 11 outputs information for specifying the current position based on characteristics of these sensors to the control circuit 17.

The input device 12 is composed of multiple mechanical switches provided for the car navigation device 10, a touch panel overlaid on the display surface of the display device 13, and a microphone. Signals are generated when a user presses the mechanical switch, touches the touch panel, and inputs voice using the microphone. The input device 12 outputs these signals to the control circuit 17.

The display device 13 has an image display device and a speaker. The image display device provides users with video such as a map based on image signals output from the control circuit 17. The speaker generates audio signals output from the control circuit 17.

The radio module 14 performs specified D/A conversion, amplification, modulation, and frequency conversion for data received from the control circuit 17. The radio module 14 outputs resulting signals to the antenna 15. The radio module 14 performs specified frequency conversion, amplification, demodulation, and A/D conversion. The radio module 14 outputs resulting signals to the control circuit 17. The radio module 14 operates in compliance with the standards for DSRC (Dedicated Short Range Communication), Bluetooth, wireless LAN, and cellular communication.

The external storage medium 16 exemplifies storage media such as HDD and stores programs, map data, and the like the control circuit 17 reads and executes. The map data includes road data indicating multiple roads, arrangement of the roads, and their widths as well as point data such as positions and names of large intersections, highways, interchanges for toll roads, bridges, shops, and public facilities along the roads.

The control circuit 17 has RAM, ROM, and a CPU (not shown). The CPU reads a program for operations of the car navigation device 10 from the ROM and the external storage medium 16 and executes the program. During execution of the program, the CPU reads information from the ROM, the RAM, and the external storage medium 16. The CPU writes the information to the RAM and the external storage medium 16. The CPU exchanges signals with the position detector 11, the input device 12, the display device 13, and the radio module 14. The CPU receives signals indicating on-, ACC-, and off-positions of a vehicle engine switch from the ignition line 18.

The CPU of the control circuit 17 executes the program to specifically perform a current position specification process, a guiding route retrieval process, and a route guidance process. Based on signals from the position detector 11, the current position specification process uses known technologies such as the map matching technology using shapes of roads and multistory car parks to specify the vehicle's current position. The guiding route retrieval process accepts user input about a destination and calculates an optimum guiding route from the current position to the destination. The route guidance process reads map data from the external storage medium 16 and allows the display device 13 to graphically display the calculated traveling route and memory points along with the map data. Further, the route guidance process allows the display device 13 to audibly output the turning direction at an intersection and prompts a user to drive along the guiding route.

The external storage medium 16 according to the embodiment ensures an area that stores facility data and guidance voice data to be used for the route guidance process.

FIG. 2 shows the configuration of the facility data in a table format. The facility data is composed of multiple facility entries. Except the first row in the table of FIG. 2, each of the other rows represents one facility entry. One facility entry has multiple information items concerning the facility. Facilities in this specification signify artifacts such as buildings, parking areas, and roads that can be visited by a vehicle. In the table of FIG. 2, each column represents one item.

The items include “facility,” “location,” “additional voice data,” “miscellaneous information,” “service history,” “voice guidance registration,” and “category.”

The “facility” item stores information indicating names of facilities associated with the entry (e.g., names of theme parks, companies, department stores, fast-food chains, convenience stores, gas station chains, national roads, and parking areas).

The “location” item stores location information such as latitude and longitude, place name, and house name about a targeted facility.

The “additional voice data” item stores voice data such as formal name and abbreviated name representing the nominal designation of a targeted facility. Alternatively, the “additional voice data” item stores a pointer indicating the location of the voice data in the external storage medium 16. The voice data is stored in such formats as WAV and MP3 (Mpeg1 Audio Layer3). The voice data is not limited to the nominal designation and may provide guidance about the facility.

The “miscellaneous information” item stores information not belonging to the other items such as a targeted facility's telephone number, Web site URL, shop opening hours, and surrounding area information.

The “service history” item stores the service history information about a targeted facility. The history includes dates and the like on the service or traveling basis.

The “voice guidance registration” item stores a flag value indicating whether or not to use the additional voice data in the same entry for the voice guidance.

The “category” item stores types of business such as restaurant, theme park, parking area, and highway concerning a targeted facility.

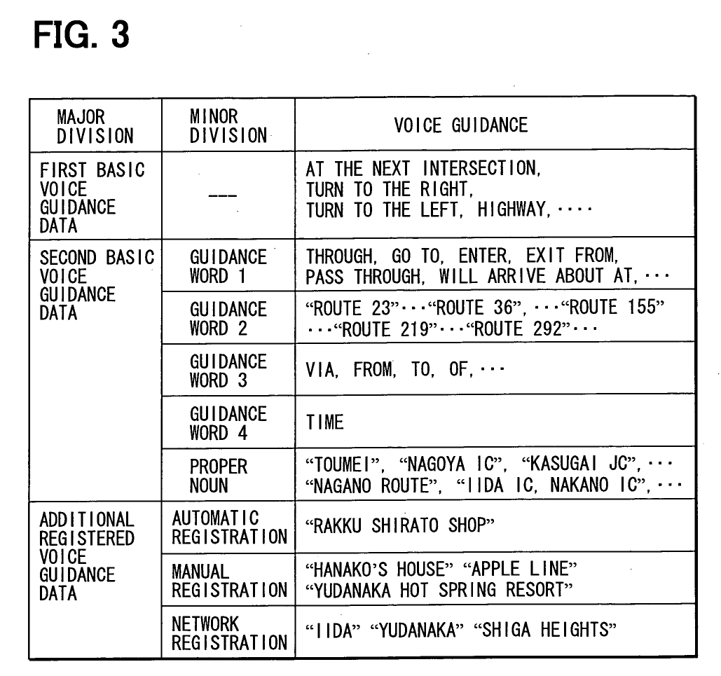

FIG. 3 shows examples of the guidance voice data in a table form. There is multiple pieces of guidance voice data. Each data belongs to any of three major divisions, i.e., first basic voice guidance data, second basic voice guidance data, and additional voice guidance data.

The first basic voice guidance data contains, for example, “next intersection,” “turning to the right,” “turning to the left,” “highway,” and the like that are independent of a specific facility and specify simple traveling modes for a vehicle.

Voice guidance data belonging to the second basic voice guidance data belongs to any of five minor divisions, i.e., guidance word 1, guidance word 2, guidance word 3, guidance word 4, and proper noun.

The guidance word 1 contains such voice guidance data as “by way of,” “going to,” “exiting from,” “passing through,” and the like that are independent of a specific road or facility and specify traveling modes for a vehicle in more detail than the first basic voice guidance data.

The guidance word 2 contains such voice guidance data as route 23, route 155, and similar specific roads. This voice guidance data is generated through a simple combination of “route” plus a numeric. The external storage medium 16 may store this voice guidance data as parts before the combination.

The guidance word 3 contains voice guidance data expressing particles such as “at,” “from,” “to,” and the like.

The guidance word 4 contains voice guidance data expressing the time generated by a combination of “hour,” “minute,” and “second” as well as numerics. The external storage medium 16 may store this voice guidance data as parts before the combination.

The proper noun contains such voice guidance data as “Toumei,” “Nagoya Interchange,” “Kasugai Junction,” “Nagano Route,” and the like, i.e., names of public facilities and main roads that are highly possibly used by many people.

The external storage medium 16 already stores the first basic voice guidance data and the second basic voice guidance data at the stage of mounting the car navigation device 10.

The additional voice guidance data contains voice guidance data that further belongs to any of minor divisions such as automatic registration, manual registration, and network registration.

The automatic registration relates to voice guidance data to be downloaded through the communication equipment that is installed at a specific facility such as “Rakku Shirato Shop” to be described later.

The manual registration contains such voice guidance data as “Hanako's house,” “Apple Line,” “Yudanaka Hot Spring Resort,” and the like that are manually registered by a user of the car navigation device 10 to be described later.

The network registration contains such voice guidance data as “Iida,” “Yudanaka,” “Shiga Heights,” and the like that are downloaded via communication lines such as the Internet and concern facilities far from the vehicle's position. The car navigation device 10 may be provided with a communication device (e.g., wireless LAN card) for downloading data via wide area networks such as the Internet.

The following describes how the car navigation device 10 obtains and stores the automatically registered voice guidance data in the external storage medium 16.

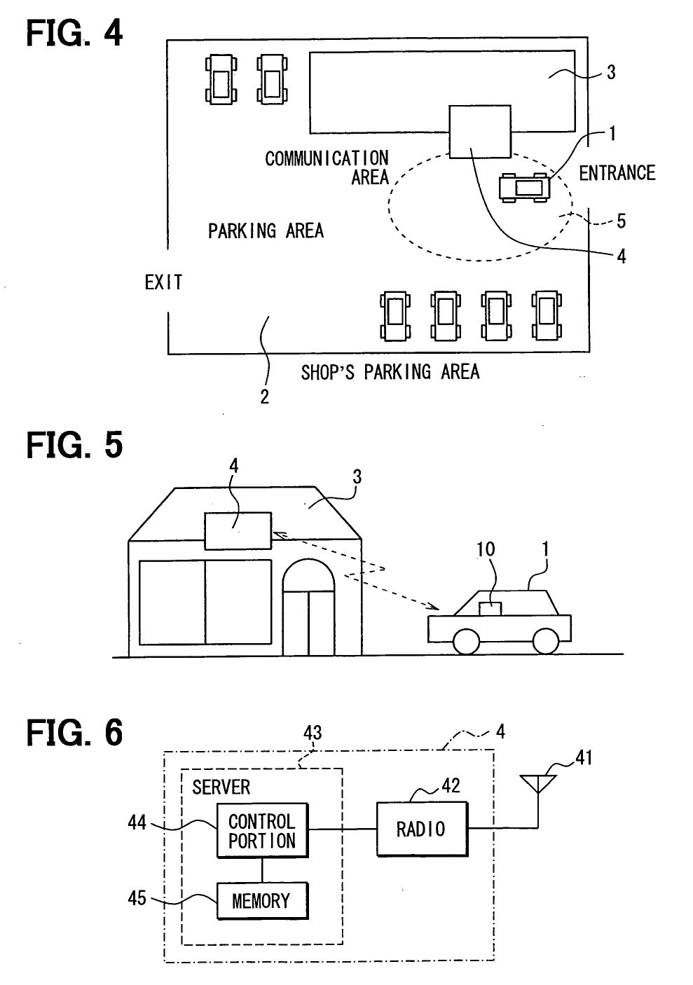

FIG. 4 shows an aerial view of a facility where the car navigation device 10 receives voice guidance data. A vehicle 1 mounted with the car navigation device 10 enters a parking area 2 in the facility and stops in a communicable area 5 for communication equipment 4 installed in a building 3.

FIG. 5 shows a side view of the vehicle 1 and the facility building 3. When the vehicle 1 enters the communicable area 5, the car navigation device 10 thereof makes standardized communication such as DSRC with the communication equipment 4. During the communication, the car navigation device 10 receives voice guidance data and stores it in the external storage medium 16.

FIG. 6 shows the hardware configuration of the communication equipment 4. The communication equipment 4 has an antenna 41, a radio 42, and a server 43. The server 43 has a control portion 44 and memory 45.

When the antenna 41 receives a radio signal from the car navigation device 10, the radio 42 performs frequency conversion, demodulation, amplification, A/D conversion, and the like based on the DSRC standard and the like for that signal. The radio 42 outputs resulting data to the control portion 44 of the server 43. The server 43 operates when reading and executing a program from the memory 45 composed of an HDD and the like. When receiving data from the radio 42 during the operation, the server 43 generates data to be transmitted to that data and outputs the generated data to the radio 42. The radio 42 performs D/A conversion, amplification, modulation, frequency conversion, and the like based on the DSRC standard and the like for the data.

Specifically, the control portion 44 of the server 43 operates as follows. When receiving data for a request (e.g., a request for menu information) from the radio 42, the control portion 44 outputs response data for the request to the radio 42 based on the information in the memory 45.

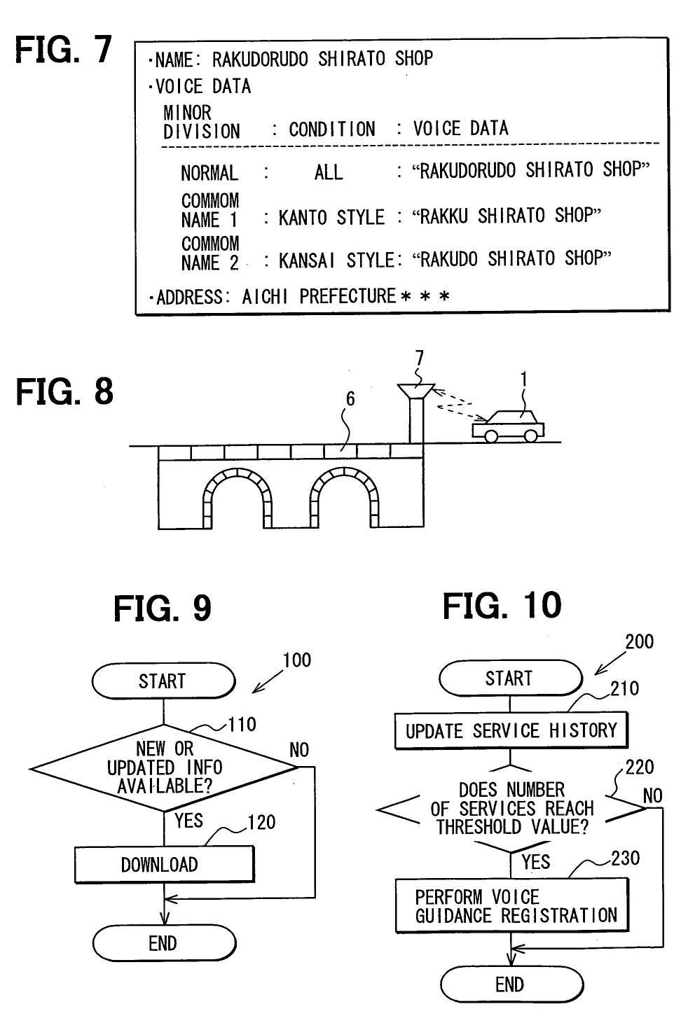

The control portion 44 reads data as shown in FIG. 7 from the memory 45 and outputs the data to the radio 42. The read data is used as detailed information about a facility to which the control portion 44 belongs.

As shown in this drawing, the detailed information about the facility contains a character string indicating a name (“Rakudorudo Shirato Shop” in the example), voice data representing the facility's name, and character string data (“Aichi Prefecture*** in the example) representing the address. The voice data is classified into three different types, i.e., general name, common name 1, and common name 2 (“Rakudorudo Shirato Shop,” “Rakku Shirato Shop,” and “Rakudo Shirato Shop” in the example).

In this manner, the facility's communication equipment 4 transmits multiple pieces of voice data about its name to the car navigation device 10. These pieces of voice data are used as detailed information about the communication equipment 4 belonging to the facility.

On a road (including a bridge), the above-mentioned communication equipment may be installed at a position such as a pole 7 beside the road of a bridge 6 in FIG. 8.

FIG. 9 shows a flowchart of a program 100 executed by the control circuit 17 to receive data as the detailed information from the communication equipment 4. When entering a communicable area of the communication equipment 4, the control circuit 17 uses the radio module 14 to establish a radio connection with the communication equipment 4. When the radio connection is established, the control circuit 17 starts executing the program 100.

At Step 110, the program determines whether or not new or updated information is available. Specifically, for example, the external storage medium 16 stores facility data whose entry for the facility contains the service history. Based on the service history, the control circuit 17 transmits transmission data to the communication equipment 4. The transmission data contains data for the time most recently communicated with the facility and data for an update information request. When the radio connection is currently established for the communication equipment 4, the control circuit 17 determines to which facility indicated by an entry in the facility data the communication equipment 4 belongs. For example, the control circuit 17 may receive information about the name of the facility from the communication equipment and determine an entry having a facility name matching the received name. Alternatively, the control circuit 17 may use the position detector 11 to specify the current position and determine an entry whose location information indicates a position within a specified range (e.g., 10 m) from the current position.

Based on the transmission data, the communication equipment 4 transmits response data composed of a name list of information (e.g., a new menu, new traffic information, a new list of charge, and the like) that may be updated from the specified time to the current time. The control circuit 17 receives the response data via the radio module 14. When the name list in the data is not empty, the control circuit 17 determines that there is new or updated information. When the name list is empty, the control circuit 17 determines that there is no new or updated information. Thereafter, the control circuit 17 terminates execution of the program 100.

When determining that there is new or updated information, the control circuit 17 performs the process at Step 120 to transmit a request for the information corresponding to the name list to the communication equipment 4. As a result, the control circuit 17 receives data associated with the request from the communication equipment 4. In this case, the requested data may include all the information stored in the name list or may be appropriately selected based on user's operations on the input device 12. The download process at Step 120 can download the voice data as shown in FIG. 7 and store it in the external storage medium 16. When there is no entry in the facility data corresponding to the facility, the control circuit 17 downloads data, assuming that new data is always available. After Step 120, the control circuit 17 terminates execution of the program 100.

The control circuit 17 may download the voice data when the number of communications with the communication equipment 4 exceeds a specified threshold value.

When terminating the execution of the program 100 as shown in FIG. 9, the control circuit 17 then executes a program 200 as depicted by a flowchart in FIG. 10.

At Step 210, the program updates the service history. That is, the current communication time is added to the service history in the entry of the facility data for the facility. When voice data is received from the communication equipment 4 during execution of the immediately preceding program 100, the additional voice data in the entry contains the storage location (address, filename, and the like) of the downloaded data in the external storage medium 16. At this time, no entry may be found in the facility data corresponding to the facility. In such case, the control circuit 17 may specify the items such as the facility name, the location, and the category based on the detailed facility information received from the communication equipment 4 as shown in FIG. 7 and create a new entry composed of these items. The facility data as shown in FIG. 2 may be previously contained in the map data of the external storage medium 16.

At Step 220, the program determines whether or not the number of services reaches a specified threshold value (e.g., three times) based on the service history item in the entry. When the threshold value is reached, the program performs the process at Step 230. When the threshold value is not reached, the program terminates the execution of the program 200.

At Step 230, the program performs the voice guidance registration. Specifically, the program turns on a flag for the voice guidance registration item in the entry. After Step 230, the execution of the program 200 terminates.

In this manner, the control circuit 17 communicates with the facility's communication equipment 4. As a result, the control circuit 17 records the information about the use of the facility as the vehicle's driving history in the facility data's service history on the external storage medium 16. When the facility is used for the number of times (or at a frequency) greater than or equal to the threshold value, the control circuit 17 communicates with the facility's communication equipment by means of radio connection for the number of times greater than or equal to the threshold value. Based on this fact, the control circuit 17 records frequently used facility information about the facility in the external storage medium 16 by turning on a voice guidance registration flag.

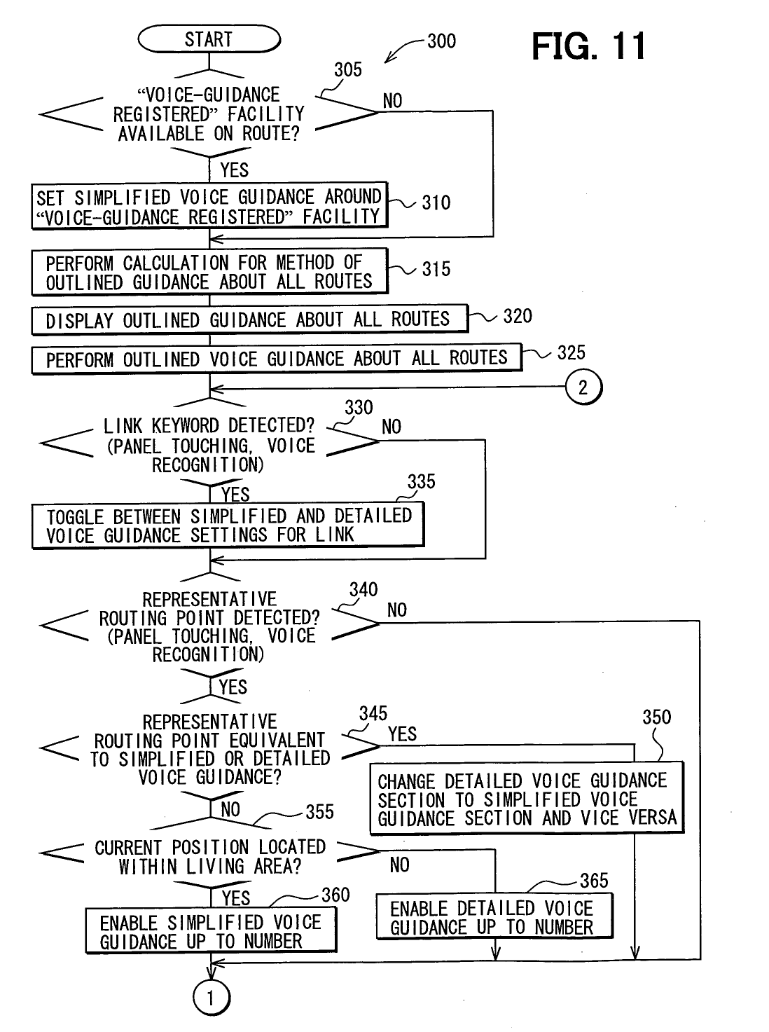

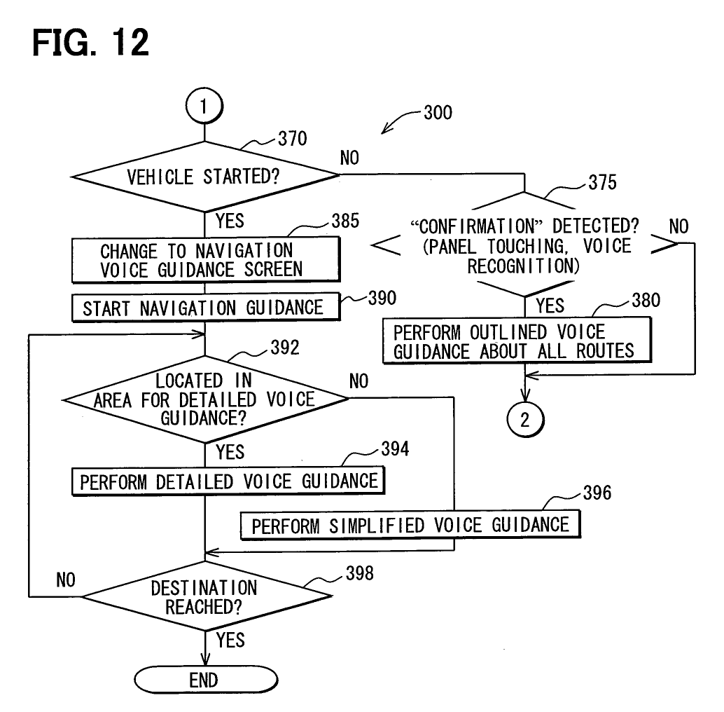

The following describes a program 300 for the route guidance process executed by the control circuit 17. FIGS. 11 and 12 show flowcharts of the program 300.

The current position specification process specifies the current position. A user specifies a destination using the input device 12 and the like. The control circuit 17 retrieves an optimum guiding route from the current position to the destination and then starts executing the program 300.

At Step 305, the program determines whether or not there is a voice-guidance registered facility on the guiding route. The “voice-guidance registered facility” signifies a facility corresponding to the entry whose voice guidance registration item has its flag turned on. The description of “facility available on the route” signifies that the facility is found along the route or constitutes part of the route road.

When the voice-guidance registered facility is found on the guiding route, the program performs the process at Step 310. When the voice-guidance registered facility is not found on the guiding route, the program performs the process at Step 315.

At Step 310, the program stores information in the RAM of the control circuit 17 so as to define a route section including the voice-guidance registered facility as the section for simplified voice guidance setting. The section in this context signifies part of the guiding route. The section may be obtained by equally dividing the guiding route into specified distances. Alternatively, the section may be a portion of the guiding route between positions registered as representative points in the map data such as large intersections, famous facilities, and interchanges.

The following describes the simplified voice guidance. According to the embodiment, the control circuit 17 performs the route guidance process in two available forms of voice guidance. One is the simplified voice guidance. The other is a detailed voice guidance. With respect to the guidance for the same section, the simplified voice guidance provides a smaller voice guidance quantity than the voice guidance quantity. The voice guidance quantity may represent how many intersections are targeted for the voice guidance.

Alternatively, for example, the voice guidance quantity may represent the degree of detail about the voice content for one voice guidance object. For example, the simplified voice guidance may provide a short expression of “turn the next intersection to the right” instead of an expression of “turn the intersection XXX meters ahead to the right” according to the detailed guidance. Further, for example, the detailed voice guidance may use formal names for the voice guidance of facilities and intersections to be guided. The simplified voice guidance may use abbreviated names and common names for the voice guidance of facilities and intersections to be guided.

The number of available voice guidance forms is not limited to two. There may be three or more forms with gradually varying voice guidance quantities.

There may be a case where the route in a given section contains at least one voice-guidance registered facility. In such case, that section is targeted for the simplified voice guidance. There may be another case where the route in a given section contains at least as many voice-guidance registered facilities as a specified threshold value. In such case, that section may be targeted for the simplified voice guidance. The specified threshold value is one or more and may bethree, for example.

In still another case, there are at least as many voice-guidance registered facilities as a specified threshold value on the route within a partial section that extends for a specified distance from and including the center point of a given section along the route. In such case, that section may be targeted for the simplified voice guidance. The reason follows. Let us consider two cases. In one case, a frequently used facility is located near the end of the section. In the other case, a frequently used facility is located near the center of the section. The latter shows a high possibility of frequently using the entire section. The specified distance may be a half of the relevant section, for example.

In yet another case, the control circuit 17 uses the external storage medium 16 to store vehicle's past driving routes. When the vehicle traveled all routes in a given section, that section may be targeted for the simplified voice guidance.

In still yet another case, a voice-guidance registered facility may be located on the guiding route. In this case, the simplified voice guidance may be applied to a section extending from that facility for a specified distance (e.g., 2 km) along the guiding route.

When a point is registered as home (or is home-registered), the simplified voice guidance may be applied to a section that includes the home-registered point.

In still yet another case, a facility may be recorded in the facility data with the voice guidance registration flag turned on and correspond to a representative routing point to be described later. In such case, the simplified voice guidance may be applied to a section from the representative routing point to the other representative routing point at both ends along the guiding route. In this case, the control circuit 17 may previously determine the representative routing point at Step 310.

At Step 310, the detailed voice guidance is applied to portions where the simplified voice guidance is inapplicable.

At Step 315, the program determines a representative routing point in the guiding route as calculation for the method of the outlined guidance about all routes. Specifically, the program reads multiple (e.g., a specified number of or the number of objects corresponding to the entire guiding route length) large intersections, interchanges of highways and toll roads, famous facilities, and the like on the guiding route from the map data. The program allows the RAM in the control circuit 17 to store information indicating that they are representative routing points. The representative routing point may be selected for a facility recorded in the facility data with the voice guidance registration flag turned on.

It is configured to limit a distance between adjacent representative routing points so as not to be smaller than or equal to a given minimum distance and not to be greater than or equal to a given maximum distance. This can suppress variations in distances between the representative routing points.

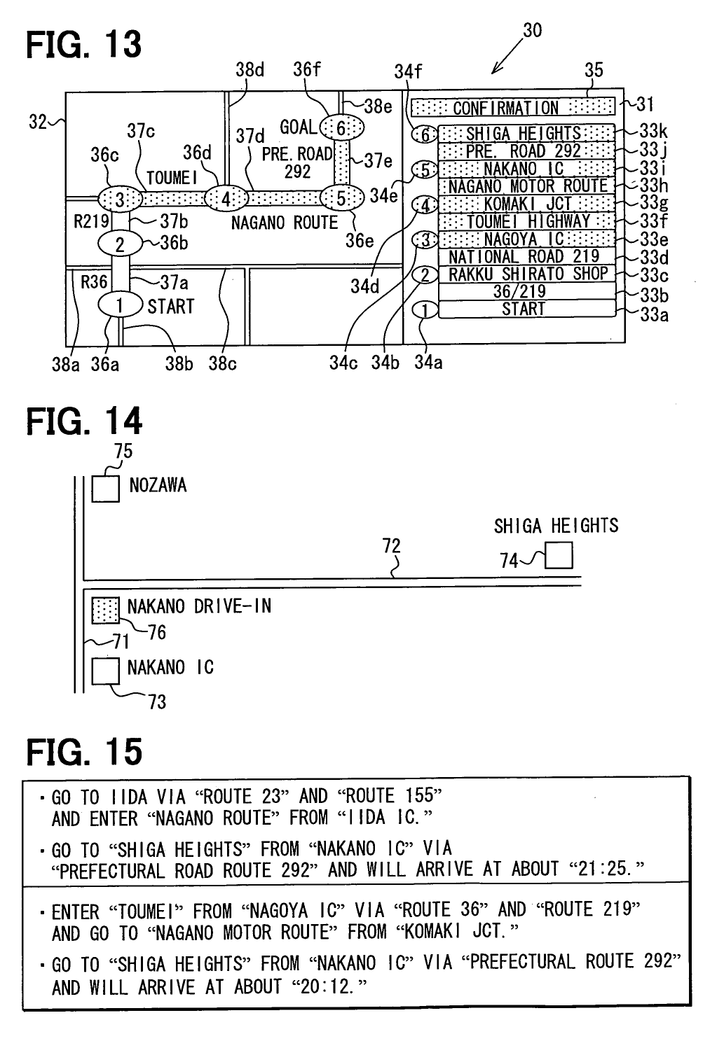

At Step 320, the program allows the display device 13 to graphically display representative routing points for the outlined guidance about all routes in the map format and the keyword list format. FIG. 13 exemplifies a display screen 30 of the display device 13 for this graphical display.

In this example, the display screen 30 is divided into two areas, i.e., a right keyword list screen 31 and a map screen 32.

The keyword list screen 31 shows keyword buttons 33a through 33k, number indications 34a through 34f, and a confirmation button 35. A set of the keyword buttons 33a through 33k is equivalent to an outlined route.

The keyword buttons 33a through 33k constitute a keyword list. One of these buttons indicates any one of representative routing point names and names of main roads in the guiding route connecting the representative routing points specified at Step 315. In FIG. 13, the keyword buttons 33a, 33c, 33e, 33g, 33i, and 33k indicate names of the representative routing points. The keyword buttons 33b, 33d, 33f, 33h, and 33j indicate names of the major roads. The keyword list is arranged in the order of occurrences in the guiding route from the bottom.

A user can select any of the keyword buttons 33a through 33k by touching the corresponding button portion with a finger or the like on a touch panel overlaid on the display surface. A user can also select the keyword buttons 33a through 33k by vocally inputting their names from a microphone and the like of the input device 12.

Of the keyword buttons 33a through 33k, the shaded ones (keyword buttons 33e through 33k in FIG. 13) correspond to a section where the detailed voice guidance is performed. The unshaded ones (keyword buttons 33a through 33d in FIG. 13) correspond to a section where the simplified voice guidance is performed. In this manner, shades or colors are used to indicate differences between the voice guidance types, thus improving the user's visibility.

The number indications 34a through 34f are used to associate numbers with the keyword buttons 33a, 33c, 33e, 33g, 33i, and 33k corresponding to the representative routing points. For example, the number indication 34d is displayed near the keyword button 33g. This makes it clear that the Komaki Junction is associated with number 4.

Like the keyword buttons 33a through 33k, the confirmation button 35 can be selected when the user touches the corresponding portion on the touch panel or vocally inputs the button name.

The map screen 32 uses a map to display the guiding route from the start point to the destination. The map screen 32 displays representative routing points 36a through 36f, links 37a through 37e, and roads 38a through 38e corresponding to the positions on the map. The representative routing points 36a through 36f are assigned numbers. These numbers correspond to the number indications 34a through 34f in the keyword list screen 31, making it possible to visually check the names of the representative routing points.

A set of the representative routing points 36a through 36f and the links 37a through 37e is equivalent to the outlined route.

The links 37a through 37e indicate a section connecting the representative routing points 36a through 36f on the guiding route. Near the links 37a through 37e, character strings are displayed to indicate the names of the major roads for the links in the section. Of these links, the shaded ones (the section of links 37c, 37d, and 37e in FIG. 13) correspond to the section where the detailed voice guidance is performed. The unshaded ones (the section of links 37a and 37b in FIG. 13) correspond to the section where the simplified voice guidance is performed. In this manner, shades or colors are used to indicate differences between the voice guidance types, thus improving the user's visibility.

As mentioned above, the links are shaded or colored to visually distinctively indicate the detailed voice guidance section and the simplified voice guidance section in units of links between the representative points. When there is a link between two adjacent representative points along the guiding route, the entire link corresponds to either the visually distinctive indication for the simplified voice guidance section or that for the detailed voice guidance section. Actually, however, one link may contain a mixture of a section for the detailed guidance and a section for the simplified guidance.

FIG. 14 shows a road diagram to describe such case. In FIG. 14, let us assume that part of the guiding route follows a road 71 and a road 72 in succession and Nakano IC 73 and Shiga Heights 74 are representative routing points in the outlined guidance. Further, let us assume that a vehicle frequently uses the route from Nakano IC 73 to Nozawa 75 and, as a result, Nakano Drive-in 76 is defined as a voice-guidance registered facility.

In this case, depending on a criterion for simplified or detailed voice guidance setting, a simplified voice guidance section may be attributed to the road 71 from Nakano IC 73 to Nakano Drive-in 76. A detailed voice guidance section may be attributed to the road 72 from Nakano Drive-in 76 to Shiga Heights 74. In such case, the detailed voice guidance section as the road 72 is longer than the other in the entire link from Nakano IC 73 to Shiga Heights 74. Accordingly, the link is displayed for the detailed voice guidance to be shaded or the like.

In this manner, one link may contain a mixture of the section for detailed guidance and the section for simplified guidance. In such case, it is determined which type of the guidance is applied to the longer section in the entire link. The link is displayed with the visually distinctive indication for that type.

Roads 38a through 38e are indicated as those excluded from the guiding route.

Each of the representative routing points 36a through 36f and the links 37a through 37e can be selected when the user touches the corresponding portion on the touch panel or vocally inputs it.

At Step 325, the program performs the outlined voice guidance about all routes. Specifically, the program allows the display device 13 to audibly present the guidance based on the representative routing points and the main roads displayed in the keyword list at Step 320.

FIG. 15 shows an example of the outlined voice guidance about all routes. In two messages of this diagram, double quotes contain keywords (i.e., representative routing points and main road names). The last double quotes contain the arrival time. The control circuit 17 uses the second basic voice guidance data as shown in FIG. 3 and appropriately combines guidance words along the guiding route to generate data for these guidance voices.

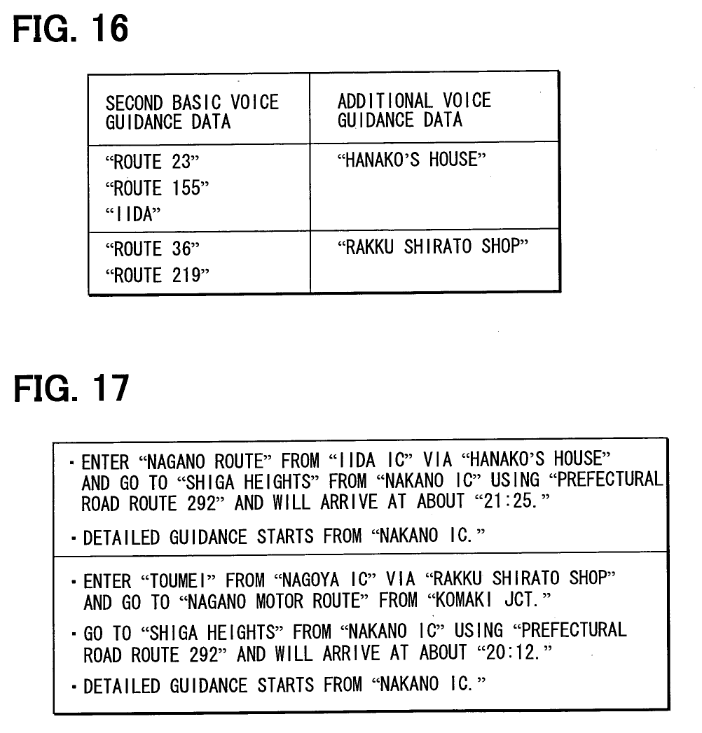

The outlined voice guidance may substitute keywords for the additional registered voice guidance data in FIG. 3 to be output vocally. FIG. 16 exemplifies a conversion table between keywords and additional registered voice guidance data. In this example, Route 23, Route 155, and Iida are replaced by words “Hanako's house.” Route 36 and Route 219 are replaced by words “Rakku Shirato Shop.”

Immediately before the outlined voice guidance at Step 325, the control circuit 17 specifies the position of the voice-guidance registered facility in the link of the voice guiding route and generates a correspondence table as shown in FIG. 16. This table describes the correspondence between two types of data. One is that specified position and nearby main roads and the like for the outlined voice guidance. The other is additional voice guidance data specified in the facility's entry belonging to the facility data stored in the external storage medium 16. Based on the correspondence table, the control circuit 17 replaces the keywords with the additional voice guidance data for voice guidance.

It may be preferable to use the additional voice guidance data only for the section where the simplified voice guidance is to be performed. This makes it possible to determine which of the simplified voice guidance and the detailed voice guidance will be performed for the section associated with the guidance according to the vocally output contents.

FIG. 17 shows guidance voices resulting from replacing the keywords with the additional voice guidance data in the guidance voices of FIG. 15. In this example, the message ‘passing through “Route 23” and “Route 155” and going to Iida’ is converted into ‘via “Hanako's house.”’ Further, the message ‘passing through “Route 23” and “Route 155”’ is converted into ‘via “Rakku Shirato Shop.”’

It may be preferable to vocally guide the information notifying which type of voice guidance is used for which section. Like the message ‘Detailed guidance starts from “Nakano IC”’ in FIG. 17, for example, it may be preferable to vocally present the information about a point from which the detailed voice guidance should be performed. Further, it may be preferable to vocally present the information about a point to which the simplified voice guidance should be performed. Furthermore, it may be preferable to vocally present the information about a point to which the detailed voice guidance should be performed. Moreover, it may be preferable to vocally present the information about a point from which the simplified voice guidance should be performed.

At Step 330 following Step 325, the program determines whether or not a link keyword is entered. The link keyword corresponds to the main road between representative routing points displayed in the keyword list screen 31. Specifically, the program checks a signal from the input device 12 to detect whether a user uses the touch panel to touch any of the keyword buttons 33b, 33d, 33f, 33h, and 33j and the links 37a through 37e or uses the microphone to vocally input a link keyword. When a link keyword is input, the program performs the process at Step 335. When no link keyword is input, the program performs the process at Step 340.

At Step 335, the program toggles between the simplified and detailed voice guidance for the section corresponding to the input link keyword. That is, the program changes the voice guidance setting for the section from the simplified voice guidance to the detailed voice guidance or from the detailed voice guidance to the simplified voice guidance.

On the outlined display in FIG. 13, for example, a user touches the keyword button 33h or the link 37d or utters “Nagano Motor Route” using the microphone. The control circuit 17 determines that the link keyword is input at Step 330. At Step 335, the control circuit 17 changes the voice guidance setting from the detailed voice guidance to the simplified voice guidance for the section corresponding to the link, i.e., the section between Komaki JCT to Nakano IC. The control circuit 17 turns off the shading displayed for the link 37d and the keyword button 33h.

On the outlined display in FIG. 13, for example, the user touches the keyword button 33b or the link 37a or utters “Route 36 and Route 219” using the microphone. The control circuit 17 determines that the link keyword is input at Step 330. At Step 335, the control circuit 17 changes the voice guidance setting from the simplified voice guidance to the detailed voice guidance for the section corresponding to the link, i.e., the section between the start point (current position) to Rakku Shirato Shop. The control circuit 17 adds shading to the display of the link 37a and the keyword button 33b.

According to the process at Steps 330 and 335, the control circuit 17 detects the link specification in the outlined display of all routes. The control circuit 17 toggles the voice guidance settings for the section corresponding to the link associated with the specification.

Following Step 335, the program performs the process at Step 340.

At Step 340, the program determines whether or not a keyword for the representative routing point is input. Specifically, based on a signal from the input device 12, the program detects whether the user uses the touch panel to touch any of the keyword buttons 33a, 33c, 33e, 33g, 33i, and 33k and the representative routing points 36a through 36f. Alternatively, the program detects whether the user uses the microphone to vocally input the keyword for the representative routing point or the number given to the representative routing point on the display screen 30. When a keyword for the representative routing point is input, the program performs the process at Step 345. When no keyword is input, the program performs the process at Step 370 in FIG. 12.

At Step 345, the program determines whether or not the representative routing point corresponding to the input keyword is equivalent to a change point between the section for the simplified voice guidance and the section for the detailed voice guidance. When the representative routing point is equivalent to the change point, the program performs the process at Step 350. Otherwise, the program performs the process at Step 355.

At Step 350, the program changes the detailed voice guidance section to the simplified voice guidance section and vice versa in all sections. That is, the program changes the voice guidance settings from the simplified voice guidance to the detailed voice guidance and vice versa for the section from the representative routing point to one end (representative routing point 36a or 36f in FIG. 13). Likewise, the program changes the voice guidance settings from the simplified voice guidance to the detailed voice guidance and vice versa for the section from the representative routing point to the other end.

With reference to the outlined display in FIG. 13, for example, let us assume that the user touches the keyword button 33e or the representative routing point 36c or utters “Nagoya IC” using the microphone. At Step 340, the control circuit 17 determines that a keyword is input for the representative routing point. At Step 345, the control circuit 17 determines that the representative routing point is a change point. At Step 350, the control circuit 17 changes the voice guidance setting for the section between the start point and Nagoya IC from the simplified voice guidance to the detailed voice guidance. The control circuit 17 changes the voice guidance setting for the section between Nagoya IC and Shiga Heights from the detailed voice guidance to the simplified voice guidance. In addition, the control circuit 17 changes the shaded and unshaded displays according to the settings.

Following Step 350, the program performs the process at Step 370 in FIG. 12.

At Step 355, the program determines whether or not the current position, i.e., the start point, is located within a living area. Whether or not the current position is located within a living area depends on whether or not the point is home-registered. The home registration is characterized as follows. The user uses the input device 12 to specify that a given location on the map is his or her home. Based on this specification, the control circuit 17 allows the external storage medium 16 to store data indicating that the location is the user's home.

Whether or not the point is located within the living area may be determined depending on whether or not the number of used facilities near (e.g., within 5 km of) the point is greater than or equal to a specified count (e.g., 5, equivalent to the first specified count according to the Claims). The used facility is characterized by a nonempty entry for the service history in the facility data stored in the external storage medium 16.

Whether or not the point is located within the living area may be determined depending on whether or not the number of frequently used facilities near (e.g., within 5 km of) the point is greater than or equal to a specified count (equivalent to the first specified count according to the Claims). The frequently used facility is characterized by an enabled value for the voice guidance registration entry in the facility data stored in the external storage medium 16.

When the current position is located within the living area, the program performs the process at Step 360. Otherwise, the program performs the process at Step 365.

At Step 360, the program configures setting to enable the simplified voice guidance for the section between the representative routing point detected at Step 340 and the current point. The program configures setting to enable the detailed voice guidance for the section between the representative routing point and the other end (the destination according to the embodiment). The program also changes the shaded or unshaded indication on the display screen accordingly.

At Step 365, the program configures setting to enable the detailed voice guidance for the section between the representative routing point detected at Step 340 and the current point. The program configures setting to enable the simplified voice guidance for the section between the representative routing point and the other end (the destination according to the embodiment). The program also changes the shaded or unshaded indication on the display screen accordingly.

According to the process at Steps 355, 360, and 365, the control circuit 17 performs the simplified voice guidance for the section between the representative routing point specified at Step 340 and the start point of the outlined route in the living area. The control circuit 17 performs the detailed voice guidance for the section between that representative routing point and the other end point.

Apart from the start point, let us suppose that one of the end points of the outlined route is located within the living area. In this case, the simplified voice guidance may be performed between the specified representative routing point and the end point. The detailed voice guidance may be performed between the representative routing point and the other end.

There may be a case where either end point of the outlined route is a sightseeing spot or an unfamiliar region. In such case, the detailed voice guidance may be performed between the specified representative routing point and the end point. The simplified voice guidance may be performed between the representative routing point and the other end. Whether or not a given point is a sightseeing spot may be determined depending on whether or not there is a famous place of scenic beauty and historic interest near that point (e.g., within 1 km from the point) in the map data. Whether or not a given point is an unfamiliar region may be determined depending on whether or not the number of facilities used near the point (e.g., within 5 km from the point) is smaller than or equal to a specified count (e.g., two being smaller than the first specified count, equivalent to a second specified count according to the Claims).

Following Steps 360 and 365, the program performs the process at Step 370 in FIG. 12.

At Step 370, the program determines whether or not a vehicle starts. Specifically, the program checks a signal from the vehicle speed sensor of the position detector 11 to determine whether or not the vehicle's running speed becomes greater than or equal to a specified speed (e.g., 5 km/h). Further, it may be preferable to check a signal from the ignition line to determine whether or not the key is set to the on-position. When the vehicle starts, the program proceeds to Step 385. Otherwise, the program proceeds to Step 375.

At Step 375, the program determines whether or not whether the user makes an input for confirmation. Specifically, the program determines whether or not the user touches the conformation button 35 on the display screen 30 in FIG. 13 or utters a word “confirmation” using the microphone. When the confirmation is input, the program performs the process at Step 380. Otherwise, the program performs the process at Step 330 in FIG. 11.

At Step 380, like Step 325, the program performs the outlined voice guidance about all routes. Following Step 380, the program performs the process at Step 330.

According to the process at Steps 370, 375, and 380, the control circuit 17 allows a manual change between the simplified and detailed voice guidance based on the link keyword specification (see Step 330) and the representative routing point specification (see Step 340) until the vehicle starts. The control circuit 17 repeats the outlined voice guidance each time the confirmation event is input (Step 375).

At Step 385 after the vehicle starts, the program terminates the outlined display for all guiding routes and provides a screen display for the normal route guidance process.

At Step 390, the program starts the route guidance process along the vehicle's travel.

At Step 392, the program determines whether or not the current point is located in the section specified for the detailed voice guidance. When the section is specified for the detailed voice guidance, the program proceeds to Step 394 to provide the route guidance according to the detailed voice guidance. Otherwise, the program proceeds to Step 396 to provide the route guidance according to the simplified voice guidance.

Following Steps 394 and 396, at Step 398, the program determines whether or not the vehicle reaches the destination. When the vehicle does not reach the destination, the program performs the process at Step 392. When the vehicle reaches the destination, the program 300 terminates.

According to the process at Steps 385 through 398, the control circuit 17 performs the detailed voice guidance or the simplified voice guidance along the guiding route to the destination based on the setting.

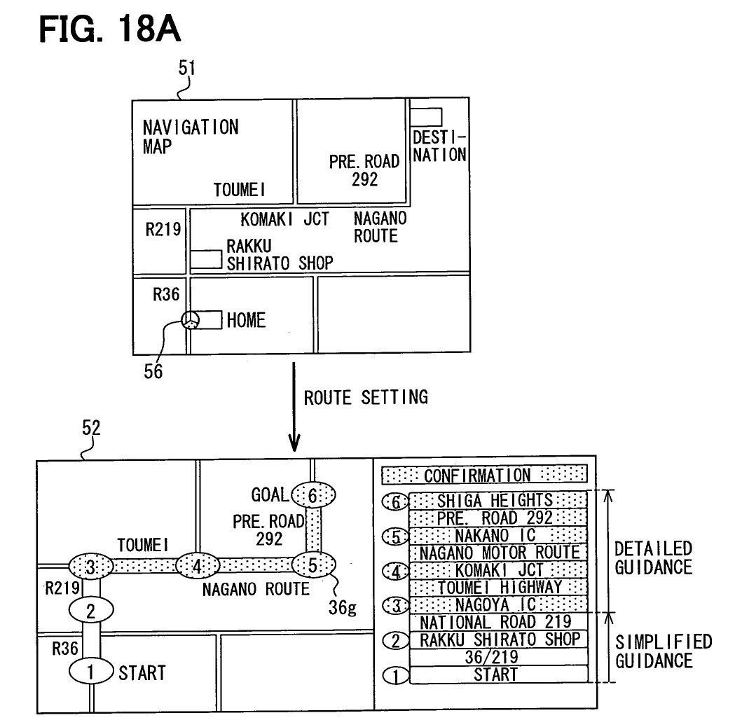

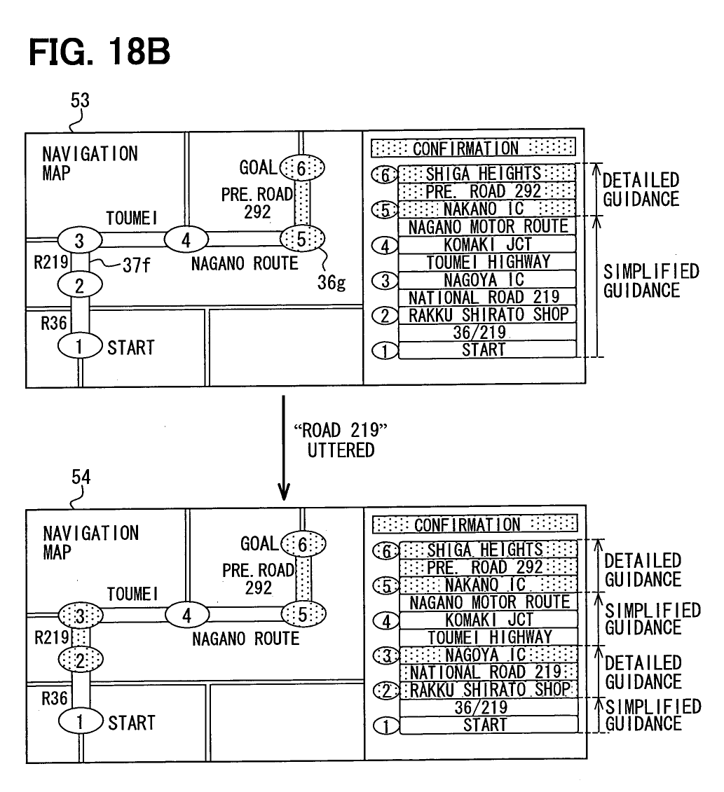

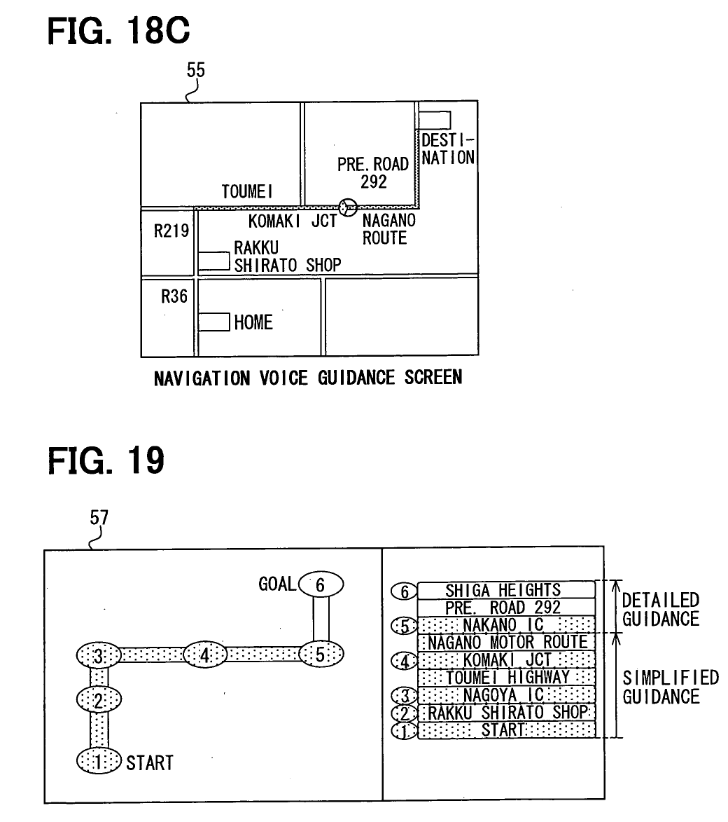

FIGS. 18A through 18C exemplify transition of the screen displays on the display screen 13 when the control circuit 17 executes the program 300.

It is assumed that the vehicle is located at a home-registered position. The car navigation device 10 allows the display device 13 to display a display screen 51 overlapped with a vehicle's position mark 56 on the map screen 10. At this time, a user operates the input device 12 to specify a destination. The control circuit 17 estimates an optimum guiding route to the destination. Along this guiding route, the vehicle will travel national road route 36, national road route 219, Tomei Expressway, Nagano Route, and prefectural road route 282 in order.

The control circuit 17 then starts executing the program 300. According to the process at Steps 305 and 310, the control circuit 17 specifies the simplified voice guidance for the section containing Rakku Shirato Shop registered for the voice guidance on the guiding route and the section containing the user's house, i.e., the section for national road routes 36 and 219. The control circuit 17 specifies the detailed voice guidance for the other parts of the guiding route. According to the process at Steps 315, 320, and 325, the control circuit 17 presents the display screen 52 in the same form as that shown in FIG. 13 by linking the representative routing points in the guiding route. The control circuit 17 shades the portions targeted for the detailed voice guidance.

Thereafter, let us assume that the user touches or vocally inputs the representative routing point 36g, i.e., Nakano IC. At Steps 340 and 345, the control circuit 17 assumes that the specified representative routing point is not a change point. At Step 355, the control circuit 17 assumes that the current position is located within the home-registered living area. At Step 360, the control circuit 17 specifies the simplified voice guidance for the section from the current position to Nakano IC. According to this setting, the control circuit 17 changes the shaded and unshaded displays as shown in a display screen 53.

The user is then supposed to select the link 37f by touching national road route 219 or uttering “Route 210.” At Step 330, the control circuit 17 determines that a link keyword is specified. At Step 335, the control circuit 17 changes the simplified voice guidance to the detailed voice guidance for the section corresponding to national road route 219. According to the setting, the control circuit 17 shades the section as shown in a display screen 54.

When the user starts the vehicle, the screen display changes to a normal route guidance display screen 55 according to the process at Step 385 and later.

When the display screen 53 is displayed, the user may touch or vocally input the representative routing point 36g, i.e., Nakano IC. At Steps 340 and 345, the control circuit 17 determines that the user specifies the representative routing point as a change point. At Step 350, the control circuit 17 changes the settings of the simplified voice guidance and the detailed voice guidance for the current sections. According to the settings, the control circuit 17 changes the shaded and unshaded displays as shown in a display screen 57 of FIG. 19. The outlined guidance may omit the display of the roads other than the guiding route and the confirmation button as shown in the display screen 57 of FIG. 19.

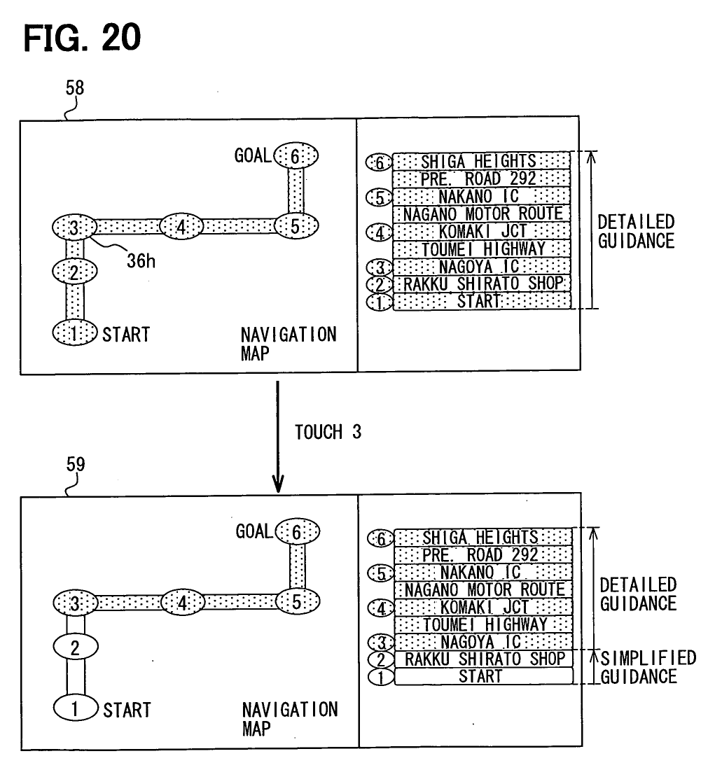

At Step 305, the detailed voice guidance may be specified for the entire guiding route because the guiding route has no voice-guidance registered facilities, for example. In such case, all the representative routing points and links are shaded as shown in a display screen 58 of FIG. 20.

On this display screen 58, the user may touch or vocally input the representative routing point 36h, i.e., Nagoya IC. At Steps 340 and 345, the control circuit 17 determines that the specified representative routing point is not a change point. At Step 355, the control circuit 17 assumes that the current position is located within the home-registered living area. At Step 360, the control circuit 17 specifies the simplified voice guidance for the section from the current position to Nagoya IC. According to this setting, the control circuit 17 changes the shaded and unshaded displays as shown in a display screen 59.

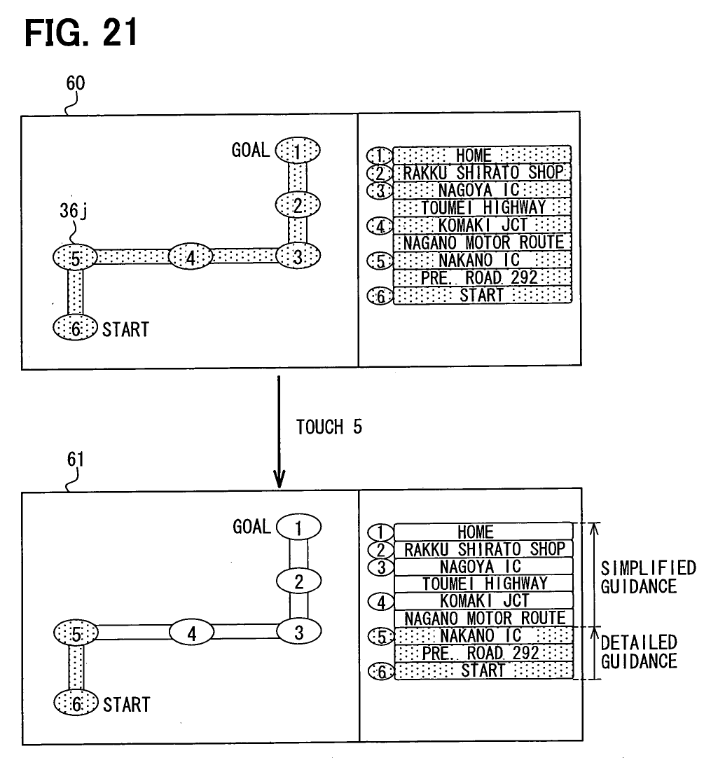

There may be a case where the start point of the guiding route may be an unfamiliar place such as a sightseeing spot, the detailed voice guidance is specified for the entire guiding route. As shown in a display screen 60 of FIG. 21, all representative routing points and links are shaded.

On this display screen 60, the user may touch or vocally input the representative routing point 36j, i.e., Nakano IC. At Steps 340 and 345, the control circuit 17 determines that the specified representative routing point is not a change point. At Step 355, the control circuit 17 assumes that the current position is not located within the home-registered living area. At Step 365, the control circuit 17 specifies the simplified voice guidance for the section from the current position to Nakano IC. According to this setting, the control circuit 17 changes the shaded and unshaded displays as shown in a display screen 61.

According to the above-mentioned operation, the car navigation device 10 allows the external storage medium 16 to record the voice guidance registration flag as the vehicle's driving history. This recording is based on the fact that the facility has been used for the number of times greater than or equal to a threshold value. When a given section in the guiding route contains a facility with the voice guidance registration flag enabled, the car navigation device 10 uses the simplified voice guidance for the section. This makes it possible to change voice guidance quantities based on the facility utilization as the driving history.

The voice guidance registration flag may be also regarded as data indicating that the facility's additional guidance voice data for the voice guidance.

As mentioned above, even the same running section causes the voice guidance quantity to automatically change depending on the vehicle's driving history. The result more or less depends on whether or not the vehicle's driver has a sense of locality.

According to the above-mentioned embodiment, the outlined guidance is performed for all guiding routes. The outlined guidance may be performed for part of the guiding routes, not for all thereof.

In a charged parking area using ETC (Electric Toll Collection), the ETC communication may be made between an ETC road unit in the parking area and the radio module 14. A fact of making this communication may update the communication history for the parking area entry in the facility data.

### Second Embodiment

The following describes a second embodiment of the present invention. According to the embodiment, the car navigation device 10 adds reverse route guidance to the operations according to the first embodiment. The voice guidance quantity of the reverse route guidance is assumed to be the same as the voice guidance quantity for a section in the guiding route corresponding to the reverse route.

The reverse route guidance is used for a return to the home from a pleasure resort, for example. After the vehicle travels a given guiding route, the reverse route guidance guides the vehicle along a route reverse to the guiding route. The reverse route guidance is performed based on a user's operation to request the reverse route guidance using the input device 12.

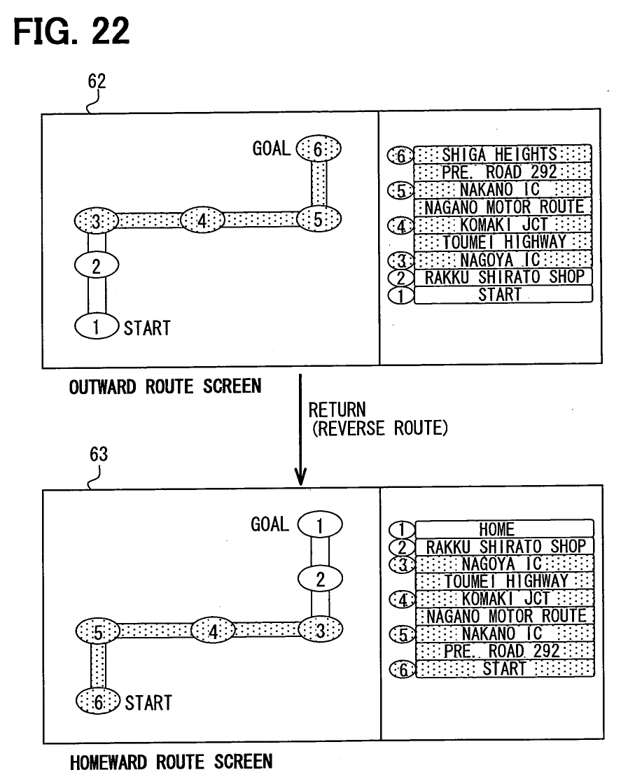

The outlined route guidance is also performed during the reverse route guidance. FIG. 22 shows comparison between outlined voice guidance screen displays for the normal route guidance and the reverse route guidance corresponding to the route guidance.

A display screen 62 is the outlined guidance screen for the normal route guidance. A display screen 63 is the outlined guidance screen for the corresponding reverse route guidance. The arrangement of representative routing points in the display screen 63 is reverse to that in the display screen 62. In both display screens 62 and 63, completely the same simplified or detailed voice guidance is attributed to each link between adjacent representative routing points.

For example, the display screen 62 shows the link from Nagoya IC to Komaki JCT as an outward route and shades it to indicate that the detailed guidance is specified for the screen display. The display screen 63 shows the link from Komaki JCT to Nagoya IC as a homeward route and also shades it to indicate that the detailed guidance is specified for the screen display.

In this manner, the reverse route can also use the voice guidance quantity setting for the corresponding guiding route.

### Third Embodiment

The following describes a third embodiment of the present invention. There may be a case where one link contains two or more voice-guidance registered facilities in the outlined voice guidance about all routes using registered voice guidance data. In the third embodiment, the car navigation device 10 according to the first embodiment performs the outlined voice guidance using registered voice guidance data for a facility nearest to the center of the link.

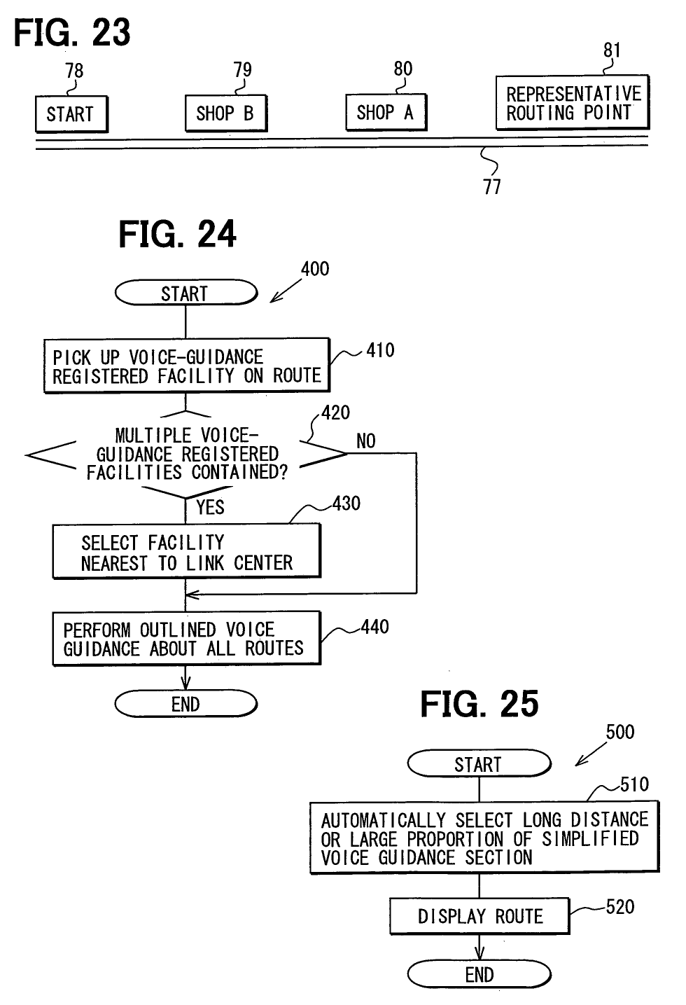

FIG. 23 shows a road diagram to explain the selection of a facility for outlined voice guidance. A road 77 is part of the guiding route. A link is formed between a start point 78 and a representative routing point 81. In this link, there are two voice-guidance registered facilities, a shop B 79 and a shop A 80. Of the two shops, the shop A 80 is nearer to the link center than the shop B 79. The registered voice guidance data for the shop A 80 is used to perform the outlined voice guidance for the link.

FIG. 24 shows a flowchart of a program 400 performed by the control circuit 17 for this operation. The control circuit 17 performs the flowchart as a substitute for Steps 320 and 325 of the program 300 in FIG. 11.

At Step 410, the program picks up a voice-guidance registered facility for each link on the guiding route.

At Step 420, the program determines whether or not one link contains multiple voice-guidance registered facilities. When one link contains multiple voice-guidance registered facilities, the program performs the process at Step 430. Otherwise, the program performs the process at Step 440.

At Step 430, the program selects one of the facilities that is nearest to the link center. The program then performs the process at Step 440.

At Step 440, the program performs the outlined voice guidance about all routes using the facility selected at Step 430 or one facility in the link. The outlined voice guidance may be performed for not only all routes, but also part of all routes, i.e., a partial route.

### Fourth Embodiment

The following describes a fourth embodiment of the present invention. In this embodiment, the car navigation device 10 according to the first embodiment retrieves guiding routes based on positions of frequently used facilities such as those voice-guidance registered.

FIG. 25 shows a flowchart of a program 500 executed by the control circuit 17 to perform a guiding route retrieval process according to this embodiment. For example, the user operates the input device 12 to specify a destination. When receiving the specified destination, the control circuit 17 retrieves an optimum route to the destination at Step 510. When selecting routes, the control circuit 17 gives preference to a route that has a long distance or a large proportion of simplified voice guidance section, i.e., a route that contains more voice-guidance registered facilities than the other routes.

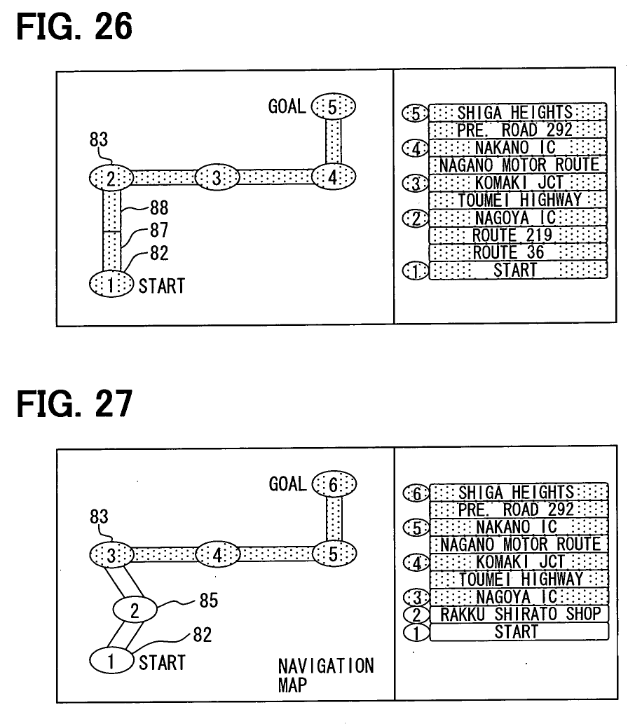

FIGS. 26 and 27 show outlined guidance displays provided by the car navigation device 10 to present a comparison between the route retrieval according to the embodiment and the other route retrieval. FIG. 26 depicts a guiding route resulting from the route retrieval independently of whether a voice-guidance registered facility is available. FIG. 27 depicts a guiding route retrieved by the car navigation device according to the embodiment.

FIG. 26 shows the guiding route between a start point 82 and Nagoya IC 83 passing through a national road route 36 (87) and a national road route 219 (88) as the shortest course. FIG. 27 depicts a screen display according to the embodiment and shows a detour as the guiding route passing through Rakku Shirato Shop 85 that does not belong to the shortest course. The reason follows. Rakku Shirato Shop 85 is a voice-guidance registered facility. Further, there is no voice-guidance registered facility on the national road route 36 (87) and the national road route 219 (88).

In this manner, the user can be provided with the route guidance that preferentially uses the familiar road.

### Fifth Embodiment

The following describes a fifth embodiment of the present invention. There may be a case where the simplified voice guidance is performed when the vehicle deviates from the guiding route not excessively. In such case, according to the embodiment, the car navigation device 10 according to the first embodiment further provides the voice guidance so as to return to the guiding route using one of two available guiding route restoration voice guidance systems, i.e., using the one having the smaller voice guidance quantity. The guiding route restoration voice guidance vocally provides the reroute guidance, i.e., the route guidance for returning to the original guiding route from the current position.

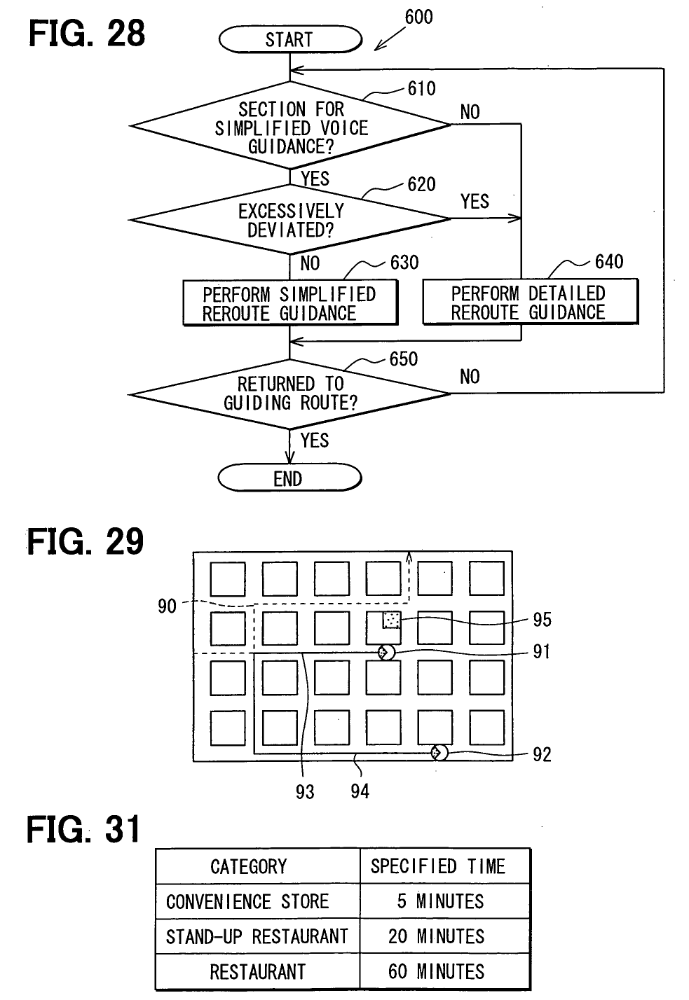

FIG. 28 shows a flowchart of a program 600 executed by the control circuit 17 according to the embodiment so as to perform the voice reroute guidance.

During the route guidance, the control circuit 17 executes the program 600 when the vehicle's current position deviates from the guiding route for a first specified distance (e.g., 10 m).

At Step 610, the control circuit 17 determines whether the simplified voice guidance or the detailed voice guidance has been performed as the voice route guidance form immediately before the deviation from the guiding route.

When the simplified voice guidance has been performed, the control circuit 17 performs the process at Step 620. When the detailed voice guidance has been performed, the control circuit 17 performs the process at Step 640.

At Step 620, the control circuit 17 determines whether or not the current position excessively deviates from the guiding route. Specifically, the current position is assumed to excessively deviate from the guiding route in the following cases. In one case, returning to the guiding route requires making a large turn, i.e., turning at intersections the specified number of times (e.g., twice) or more from the current position. In another case, a shortest distance from the current position to the guiding route is greater than or equal to a second specified distance (e.g., 500 m) longer than a first specified distance. When the current position excessively deviates from the guiding route, the control circuit 17 performs the process at Step 640. Otherwise, the control circuit 17 performs the process at Step 630.

At Step 630, the control circuit 17 performs the voice guidance for returning to the guiding route using the simplified reroute voice guidance. This is one of two available guiding route restoration voice guidance systems having the smaller voice guidance quantity.

At Step 640, the control circuit 17 performs the voice guidance for returning to the guiding route using the detailed reroute voice guidance. This is one of two available guiding route restoration voice guidance systems having the larger voice guidance quantity.

Following Steps 630 and 640, at Step 650, the control circuit 17 determines whether or not the vehicle returns to the guiding route. When the vehicle returns to the guiding route, the control circuit 17 terminates the execution of the program 600. Otherwise, the control circuit 17 performs the process at Step 610.

When the vehicle deviates from the guiding route, the control circuit 17 executes the program 600 to do the following. The control circuit 17 may determine that the deviated position is detected in the simplified voice guidance section (see Step 610) and that the current position deviates from the guiding route not excessively (see Step 620). In this case, the control circuit 17 performs the simplified reroute voice guidance (see Step 630).

For example, the detailed reroute voice guidance provides a vocal instruction to make a turn in such a direction as to resume the guiding route each time a intersection is reached.

The simplified reroute voice guidance includes a case of providing no voice guidance to resume the guiding route. The simplified reroute voice guidance may provide the voice guidance as needed, not at every intersection.

FIG. 29 shows an aerial view of roads for explaining distinction between performing the simplified reroute voice guidance and performing the detailed reroute voice guidance.

FIG. 29 depicts a guiding route 90 using a dotted line among roads set out in a grid. Vehicles 91 and 92 respectively travel routes 93 and 94 deviating from the guiding route. Along the guiding route 90, there is a frequently used voice-guidance registered facility 95. Accordingly, the simplified voice guidance is performed for the illustrated guiding route section.

In this case, the vehicle 91 deviating from the guiding route 90 can return to the guiding route by making a left turn once at the next intersection. The vehicle 91 is conditioned for the simplified reroute voice guidance and therefore does not receive the voice guidance instructing the left turn.

The vehicle 92 deviating from the guiding route 90 needs to turn to the left at the next intersection and make further turns at some intersections to return to the guiding route 90. Accordingly, the vehicle 92 is conditioned for the detailed reroute voice guidance and receives the voice guidance instructing the left turn at the current position.

When the vehicle deviates from the guiding route, the current position may not excessively deviate from the guiding route. In such case, it is preferable to perform the simplified reroute voice guidance. This makes it possible to decrease possibilities of frequently receiving unnecessary voice guidance for rerouting when the user temporarily and intentionally deviates from the guiding route.

### Sixth Embodiment

The following describes a sixth embodiment of the present invention. In addition to the operations according to the first embodiment, the car navigation device 10 according to the sixth embodiment may use a facility without the communication equipment for the number of times greater than or equal to a specified threshold value. In this case, the car navigation device 10 turns on the voice guidance registration flag as the frequently used facility information and stores the facility's voice guidance data in the external storage medium 16.

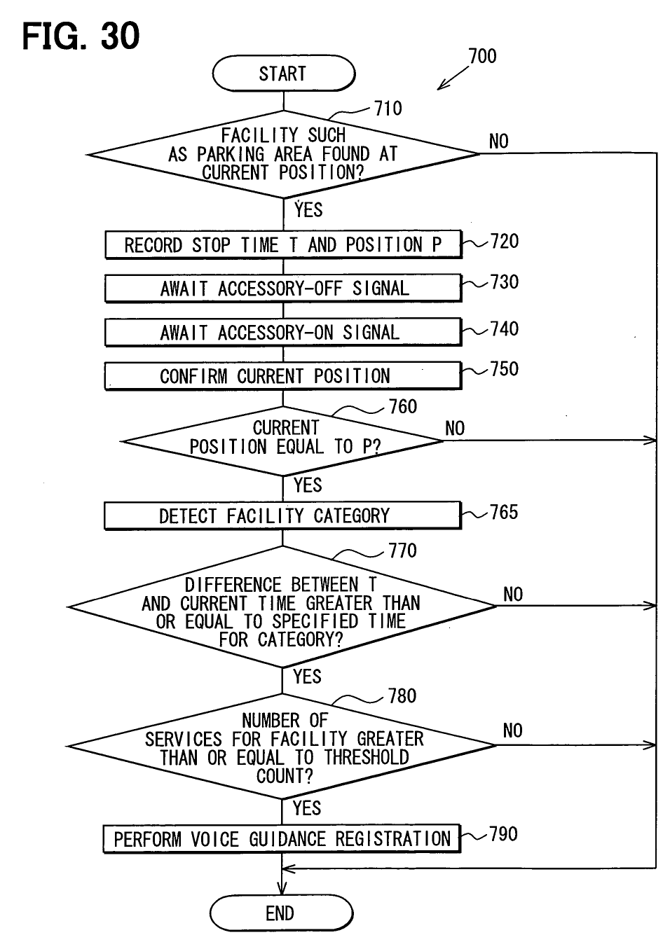

FIG. 30 shows a flowchart of a program 700 executed by the control circuit 17 so that the car navigation device 10 according to the embodiment stores the frequently used facility information about a facility without the communication equipment.

While the car navigation device 10 is operating, the control circuit 17 may detect that the vehicle has stopped by receiving a signal from the vehicle sensor or a signal from the ignition line indicating that the engine has stopped. In such case, the control circuit 17 repeatedly executes the program 700.

At Step 710, the control circuit 17 uses map data to determine whether or not there is a facility such as a parking area or a convenience store at the current position. When there is such facility, the control circuit 17 performs the process at Step 720. Otherwise, the control circuit 17 terminates the execution of the program 700.

At Step 720, the control circuit 17 allows the external storage medium 16 to store the stop time and the stop position, i.e., the current time and the current position.

At Step 730, the control circuit 17 waits until reception of an accessory-off signal (indicating the key set to the off-position) from the ignition line.

At Step 740, when receiving the accessory-off signal, the control circuit 17 waits until reception of an accessory-on signal (indicating the key moved from the off- to ACC-position) from the ignition line.

At Step 750, when receiving the accessory-on signal, the control circuit 17 calculates the current position using a current position locating function.

At Step 760, the control circuit 17 compares the current position calculated at Step 750 with the stop position stored at Step 720. When a difference is smaller than a specified distance (e.g., 1 m), the control circuit 17 assumes that the two positions are equal to each other. When a difference is greater than or equal to the specified distance, the control circuit 17 assumes that the two positions are different. When determining the two positions to be equal to each other, the control circuit 17 performs the process at Step 765. Otherwise, the control circuit 17 terminates the execution of the program 700.

At Step 765, the control circuit 17 detects the facility category. Specifically, the control circuit 17 specifies the category of, i.e., the type of business for the facility at the current position specified at Step 710 from the facility data in FIG. 2.

At Step 770, the control circuit 17 determines whether or not a difference between the stop time stored at Step 720 and the current time is greater than or equal to the specified time for the category specified at Step 765.

FIG. 31 shows specified times for the respective categories in a table form. As shown in this table, the specified times are five minutes for convenience stores, 20 minutes for stand-up restaurants, and 60 minutes for restaurants. The external storage medium 16 pre-stores this data.

The specified time for each of the categories is defined as the vehicle's stop time long enough for being highly capable of concluding the actual use of the facility. A short time is specified for a facility whose use generally requires a short time.

When the time difference is greater than or equal to the category's specified time, the control circuit 17 proceeds to Step 780. Otherwise, the control circuit 17 terminates the execution of the program 700.

At Step 780, the control circuit 17 updates the facility's service history. Further, based on the updated service history, the control circuit 17 determines whether or not the number of services for the facility is greater than or equal to a specified threshold value (e.g., 3). When the number of services is greater than or equal to the threshold value, the control circuit 17 performs the process at Step 790. Otherwise, the control circuit 17 terminates the execution of the program 700.

At Step 790, the control circuit 17 performs the voice guidance registration. Unlike the case in FIG. 10, however, the current facility has no communication equipment. There may be a case where the user can use the microphone as the input device 12 for voice input or communicate with wide-area networks such as the Internet. In this case, the voice guidance data is downloaded via the network and is stored in the external storage medium 16 as data belonging to the minor division such as the manual registration or the network registration as shown in FIG. 3. The control circuit 17 turns on the flag of the voice guidance registration as the facility entry in the facility data. After Step 790, the control circuit 17 terminates the execution of the program 700.

Since the control circuit 17 executes the program 700, the car navigation device 10 records the frequently used facility information about the facility on a storage medium. This operation is based on the fact that the vehicle stops within the facility for a time duration longer than or equal to the threshold time specified for the facility's category.

In each of the above-mentioned embodiments, the voice guidance flag is equivalent to the frequently used facility information. Further, the service history item in the facility data may be used as the frequently used facility information. The voice guidance data may be first downloaded when the number of services becomes greater than or equal to the threshold count. In such case, the downloaded voice guidance data itself may be used as the frequently used facility information.

It will be obvious to those skilled in the art that various changes may be made in the above-described embodiments of the present invention. However, the scope of the present invention should be determined by the following claims.

What is claimed is:

1. A car navigation device provided in a vehicle for performing voice guidance on a guiding route to a predetermined destination, the car navigation device comprising:
history recording means for recording a driving history of the vehicle; and
change means for changing voice guidance quantity in a given section included in the guiding route based on a driving history recorded by the history recording means concerning the given section.

2. The car navigation device according to claim 1,
wherein the history recording means records in a storage medium frequently used facility information about a facility based on use of the facility at a frequency greater than or equal to a threshold value; and
wherein, when the given section in the guiding route includes the facility associated with the frequently used facility information, the change means performs voice guidance for the given section using one of two available voice guidance systems that has a smaller voice guidance quantity.

3. The car navigation device according to claim 2,
wherein, when the facility associated with the frequently used facility information exists in a partial section containing a center point of the given section in the guiding route, the change means performs voice guidance for the given section using one of two available voice guidance systems that has a smaller voice guidance quantity.

4. The car navigation device according to claim 2, further comprising:
radio communication means,
wherein the history recording means records in the storage medium frequently used facility information about the facility based on communication with a communication device installed at the facility using the radio communication means at a frequency greater than or equal to a threshold value.

5. The car navigation device according to claim 2, further comprising:
vehicle stop detection means,
wherein the history recording means records in the storage medium frequently used facility information about the facility based on a fact that the vehicle stops longer than or equal to a threshold time in the facility at a frequency greater than or equal to a threshold value.

6. The car navigation device according to claim 5,
wherein the threshold time varies depending on types of businesses for facilities.

7. The car navigation device according to claim 2, further comprising:
outlined display means for displaying on a map an outlined route having a group of representative routing points in the guiding route to the predetermined destination,
wherein the change means performs voice guidance for a section between two representative routing points containing a position for a facility associated with the frequently used facility information in the guiding route using one of two available voice guidance systems that has a smaller voice guidance quantity.

8. The car navigation device according to claim 7, further comprising:
detection means for detecting user's specification of a representative routing point in the outlined route,
wherein the change means performs voice guidance for a section from a representative routing point concerning specification detected by the detection means to one end point of the outlined route using one of two available voice guidance systems having a smaller voice guidance quantity and performs voice guidance for a section therefrom to an opposing end point using one of two available voice guidance systems having a larger voice guidance quantity.

9. The car navigation device according to claim 8,
wherein, when one end point of the outlined route is home-registered, the change means performs voice guidance for a section from a representative routing point concerning specification detected by the detection means to the home-registered end point using one of two available voice guidance systems having a smaller voice guidance quantity.

10. The car navigation device according to claim 8,
wherein, when as many used facilities as a first specified count or more exist near one end point of the outlined route, the change means performs voice guidance for a section from a representative routing point concerning specification detected by the detection means to the one end point using one of two available voice guidance systems having a smaller voice guidance quantity.

11. The car navigation device according to claim 8,
wherein, when as many used facilities as a second specified count or less exist near one end point of the outlined route, the change means performs voice guidance for a section from a representative routing point concerning specification detected by the detection means to the one end point using one of two available voice guidance systems having a larger voice guidance quantity.

12. The car navigation device according to claim 8,
wherein, when it is configured to perform voice guidance for a section from a representative routing point in the outlined route to one end point of the outlined route using one of two available voice guidance systems having a smaller voice guidance quantity and perform voice guidance for a section therefrom to an opposing end point using one of the two available voice guidance systems having a larger voice guidance quantity, and when the detection means detects user's specification of the representative routing point, the change means performs voice guidance for the section from the representative routing point to the one end point using one of the two available voice guidance systems having a larger voice guidance quantity and performs voice guidance for the section from the representative routing point to the opposing end point using one of the two available voice guidance systems having a smaller voice guidance quantity.

13. The car navigation device according to claim 7,
wherein the outlined display means displays representative routing points in the guiding route to the predetermined destination and an outlined route including links connecting between the representative routing points on a map;
wherein detection means is provided for detecting user's specification of a link in the outlined route; and
wherein, when it is configured to perform voice guidance for a section equivalent to a link concerning specification detected by the detection means using one of two voice guidance systems with different voice guidance quantities, the change means changes voice guidance for the section so as to use an opposing of the two voice guidance systems.

14. The car navigation device according to claim 2,
wherein, when the vehicle deviates from the guiding route during voice guidance through use of one of two available voice guidance systems having a smaller voice guidance quantity and when a vehicle is able to return to the guiding route by turning at intersections less frequently than a specified number of turns, voice guidance is performed for returning to the guiding route using one of two available voice guidance systems having a smaller voice guidance quantity.

15. The car navigation device according to claim 1,
wherein, when voice guidance is performed for a reverse route to a starting point tracking reversely to a guiding route to a predetermined destination, the change means assumes voice guidance quantity for a section in the reverse route to be equal to voice guidance quantity for the section applicable to voice guidance for the guiding route.

16. The car navigation device according to claim 2,
wherein the history recording means uses the storage medium to record, as-frequently used facility information about the facility, data indicating that additional guidance voice data about the facility is to be used for the voice guidance.

17. A car navigation device in a vehicle for performing voice guidance on a guiding route to a predetermined destination, the car navigation device comprising:
outlined display means for displaying on a map an outlined route having a group of representative routing points in the guiding route to the predetermined destination,
detection means for detecting user's specification of a representative routing point in the outlined route; and
change means for performing voice guidance for a section from a representative routing point concerning specification detected by the detection means to one end point of the outlined route using one of two available voice guidance systems having a smaller voice guidance quantity and performing voice guidance for a section therefrom to an opposing end point using one of two available voice guidance systems having a larger voice guidance quantity.

18. The car navigation device according to claim 17,
wherein, when one end point of the outlined route is home-registered, the change means performs voice guidance for a section from a representative routing point concerning specification detected by the detection means to the home-registered end point using one of two available voice guidance systems having a smaller voice guidance quantity.

19. The car navigation device according to claim 17,
wherein, when as many used facilities as a first specified count or more exist near one end point of the outlined route, the change means performs voice guidance for a section from a representative routing point concerning specification detected by the detection means to the one end point using one of two available voice guidance systems having a smaller voice guidance quantity.

20. The car navigation device according to claim 17,
wherein, when as many used facilities as a second specified count or less exist near one end point of the outlined route, the change means performs voice guidance for a section from a representative routing point concerning specification detected by the detection means to the one end point using one of two available voice guidance systems having a larger voice guidance quantity.

21. The car navigation device according to claim 17,
wherein, when it is configured to perform voice guidance for a section from a representative routing point in the outlined route to one end point of the outlined route using one of two available voice guidance systems having a smaller voice guidance quantity and perform voice guidance for a section therefrom to the opposing end point using one of the two available voice guidance systems having a larger voice guidance quantity, and when the detection means detects user's specification of the representative routing point, the change means performs voice guidance for the section from the representative routing point to the one end point using one of the two available voice guidance systems having a larger voice guidance quantity and performs voice guidance for the section from the representative routing point to the opposing end point using one of the two available voice guidance systems having a smaller voice guidance quantity.

22. A car navigation device in a vehicle for performing voice guidance on a guiding route to a predetermined destination, the car navigation device comprising:
outlined display means for displaying representative routing points in the guiding route to the predetermined destination and an outlined route including links connecting between the representative, routing points on a map;
detection means for detecting user's specification of a link in the outlined route; and
change means for, when it is configured to perform voice guidance for a section equivalent to a link concerning specification detected by the detection means using one of two available voice guidance systems, changing voice guidance for the section so as to use an other of the two voice guidance systems.
